(19) United States
(12) Patent Application Publication
(10) Pub. No.: US 2011/0142185 A1
(43) Pub. Date: Jun. 16, 2011

(54) DEVICE FOR COMPRESSING A COMPACT TOROIDAL PLASMA FOR USE AS A NEUTRON SOURCE AND FUSION REACTOR

(75) Inventor: Simon Woodruff, Seattle, WA (US)

(73) Assignee: Woodruff Scientific, Inc., Seattle, WA (US)

(21) Appl. No.: 12/706,963

(22) Filed: Feb. 17, 2010

Related U.S. Application Data
(60) Provisional application No. 61/287,170, filed on Dec. 16, 2009.

(51) Int. Cl. G21B 1/05

(52) U.S. Cl. 376/121

(57) ABSTRACT

Provided are methods and devices for compression of a spheromak plasma (e.g., deuterium-trirtium (D-T)-derived) in a magnetic well configured within a plasma combustion chamber using an induction coil axially adjacent to the plasma, wherein a moveable member (e.g., piston, cam and follower) drives the induction coil toward the plasma, pushing the plasma via magnetic pressure into the magnetic well and compressing the plasma substantially adiabatically (e.g., coil motion is well below the plasma sound speed). The compression quickly increases both plasma density and temperature past the point of ignition, and after plasma burn, the coil is backed-off to allow the plasma to re-expand, providing for refueling and repetition of the compression cycle. Additionally provided are spaced annular plasma formation electrodes, suitably configured for generating and injecting magnetized plasma into a plasma combustion chamber. Preferably, spaced annular plasma formation electrodes are used in combination with moveable compression members as disclosed herein.

### CROSS-REFERENCE TO RELATED APPLICATIONS

This application claims the benefit of priority to U.S. Provisional Patent Application Ser. No. 61/287,170, filed Dec. 16, 2009 and entitled FUSION INTERNAL COMBUSTION ENGINE, which is incorporated by reference herein in its entirety.

### STATEMENT REGARDING FEDERALLY-SPONSORED RESEARCH

The invention was made with government support under Contract No. DE-FG02-06ER84449 from the United States Department of Energy (DOE). The United States government has certain rights in the invention.

### FIELD OF THE INVENTION

The present invention relates generally to the use of a magnetic coil contained in a moving member (e.g., piston) to adiabatically compress a magnetized plasma (e.g., containing deuterium and tritium fuel), to a point where plasma pressure is sufficient to achieve ignition thereof, and in more particular aspects, the compression drives the plasma temperature and density to fusion regimes, resulting in steady-state fusion power that is captured directly or in a thermal cycle to drive, for example, a turbine. Certain aspects relate to the use of such compressed plasma as a neutron source or as an energy source by capturing the neutrons in a blanket surrounding the combustion chamber.

### BACKGROUND

During the last 50 years, many concepts have been explored for economic fusion energy, the technology ultimately directed towards building a small-scale fusion power core. Fusion power has been obtained reliably from two devices: JET (Joint European Torus, Culham, UKAEA Oxfordshire, UK); and TFTR (Tokamak Fusion Test Reactor experiment, Princeton Plasma Physics Laboratory). In the next few years, two new devices, NIF (National Ignition Facility, Lawrence Livermore National Securities, LLC) and ITER (International Thermonuclear Experimental Reactor; an international tokamak [magnetic confinement fusion] research/engineering project based in Cadarache, France) will demonstrate net gain from fusion reactions.

Additionally, the last decade has seen renewed interest in plasma compression as a simple alternative to auxiliary fueling and heating. Experiments at JT-60 (JT-60 tokamak at Japan Atomic Energy Agency Naka Fusion Institute) achieved plasma compression by ramping up a poloidal field, showing increases of plasma temperature and density consistent with adiabatic compression. Unfortunately, such tokamak compression suffers from low efficiency, because most of the energy of the ramped poloidal field is put into a vacuum field outside the plasma, not in the region of interest.

Various other plasma compression schemes have been considered over the years. For example, in 1960, Post et al compressed magnetic mirror plasmas and attained electron temperatures in the keV range. In 1974, the first compression of compact torus (CT) plasmas was performed with a ramped dipole field used to drive two theta-pinch plasmas together, and claims of achieving keV ion temperatures were made (see Wells et al). Subsequently, additional schemes using multiple coils were considered in the 1970s and 1980s, culminating in a large study by EPRI (Electric Power Research Institute, Palo Alto, Calif.) for a translating ring reactor. In the mid 1980s, the Marauder and RACE experiments compressed a spheromak driven down an electrode cone. In the 1990s and 2000s came the imploding Fields Reversed Configuration (FRC) liners and tokamak experiments mentioned above in which a piston is destroyed on every pulse.

Various patents mention the use of toroidal plasmas or plasma compression for fusion power or neutron generation, for example: U.S. Pat. No. 2,993,851 to G. P. Thomson et al. (1962); U.S. patent ______); U.S. Pat. No. 4,267,488 to Daniel R. Wells (1981); U.S. Pat. No. 4,292,568 to Daniel R. Wells et al. (1981); U.S. Pat. No. 4,269,658 to Tihiro Ohkawa (1981); U.S. Pat. No. 3,141,826 to K. O. Friedrichs et al. (1964); U.S. Pat. No. 3,677,889 to F. H. Coensgen et al. (1972); U.S. Pat. No. 4,314,879 to Hartman et al. (1982); U.S. Pat. No. 4,363,777 to Yamada et al. (1982); U.S. Pat. No. 4,436,691 to Jardin et al. (1984); U.S. Pat. No. 4,601,871 to Turner (1986); U.S. Pat. No. 4,687,617 to Janos et al. (1987); U.S. Pat. No. 4,690,793 to Hitachi Ltd et al. (1987); U.S. Pat. No. 4,931,251 to Watanabe et al. (1990); and U.S. Pat. No. 5,015,432 to Koloc (1991).

There is, nonetheless, a substantial need in the art for an improved compression scheme and compression device for compression of plasmas that provides for increased efficiency and stability.

### SUMMARY OF EXEMPLARY ASPECTS

Particular aspects represent a fundamental departure from the prior art, and provide an adiabatic compression scheme for compact toroidal plasma that maintains stability and good isolation from the walls of the compression chamber throughout the compression cycle, thereby raising plasma temperature and density to levels useful for producing fusion power.

Certain aspects implement this compression scheme, and provide a plasma compression device or engine for compressing plasmas (e.g., ionized deuterium and tritium gas) to ignition, wherein a movable mechanical member (e.g., piston) is used to adiabatically compress a plasma ring, isolating it from the walls of the combustion chamber by use of magnetic fields, and wherein the plasma remains compressed for most of the cycle, with a short decompression for refueling and refluxing. In certain aspects, heat released in the chamber (e.g., in the form of neutrons and hot particles) is captured to drive, for example, a steam cycle and turbine. Significantly, no CO₂ is produced, and fuel is bred in the device.

In certain aspects, a spheromak plasma is compressed with a moving coil, representing a fundamental departure from the prior art. The spheromak is a toroidal plasma much like a tokamak, though absent toroidal field coil windings, so the volume is simply-connected providing a more appropriate and improved geometry for compression. Additionally, the spheromak configuration can be refueled at peak compression, and using a permanent movable member (e.g., piston) with integral coil allows compression to be maintained for an arbitrary amount of time. Significantly, unlike the compressed tokamak of the prior art, the instant compressing coil is kept near the plasma, thereby substantially enhancing efficiency by wasting much less energy on vacuum regions. Furthermore, keeping compression time faster than energy confinement time ensures that temperature gains will not dissipate before they build up.

In certain embodiments, the compressing member (e.g., piston) is coupled to an energy transferring member (e.g., rotating cam shaft) so that the energy for performing work on the plasma is transferred from the rotating cam, and compressed magnetic energy of the plasma can be retrieved upon piston decompression.

Particular aspects provide neutrons of sufficient fluence to allow for testing durability of various structural components under neutron bombardment.

Additional aspects provide means for converting neutron and hot particle energy to electrical power. In certain exemplary embodiments, neutrons released from the plasma are captured in a blanket surrounding the combustion chamber and hot particles are captured in a divertor chamber, axially displaced from the combustion chamber, wherein, for example, heat captured in the blanket and divertor is used to heat water and drive a steam turbine to produce electricity.

In particular exemplary aspects, the blanket fluid contains lithium, to provide for tritium breeding, to provide a source of fuel that can be burned in the device.

Particular preferred aspects provide a device for compression of a compact plasma, comprising: a variable-volume plasma combustion chamber defined by a blanket wall and a movable compression member surface; plasma formation and injecting means in communication with the combustion chamber; a plurality of magnetic field coils, positioned outside the blanket wall and suitably configured to provide for a magnetic well within the combustion chamber; a moveable compression member having at least one compression member magnetic field coil, the compression member and field coil moveable to vary the volume within the compression chamber; and compression member positioning means suitable, in operation with the compression member and field coil, to provide for cycled positioning of the compression member to provide for cycled compression and decompression of plasma within the compression chamber. In certain aspects, the plasma formation and injecting means comprises a pair of spaced annular parallel formation electrodes, suitably configured for generating and injecting magnetized compact toroidal plasma into the combustion chamber. In particular embodiments, the magnetic well is suitable for magnetically isolating plasma from the blanket wall of the combustion chamber, and the at least one compression member magnetic field coil is suitably configured to provide for magnetic isolation of the plasma from the compression member surface. In certain aspects, the moveable-member comprises at least one piston, each having at least one attached or integral magnetic field coil. Particular piston embodiments comprise a cam and a cam follower, the cam follower in operative communication between the cam and the piston to provide for cycled positioning of the piston within the combustion chamber. In certain aspects, the combustion chamber comprises a divertor opening, the device further comprising a divertor portion with a divertor chamber in flow communication with the combustion chamber via the divertor opening. In certain embodiments, the diverting chamber is defined by at least one divertor blanket wall and at least one divertor target surface suitably configured to receive hot particles from the combustion chamber, and the divertor comprises a plurality of divertor magnetic field coils, and at least one exhaust gas port. In particular aspects, the divetor comprises a divertor shielding plug having a blanket wall, the diverter shielding plug and blanket wall suitably configured to shield the internal diverter chamber surfaces from particle bombardment from the combustion chamber. In preferred aspects, the plasma comprises a quasi-steady state spheromak plasma having approximately equal magnitudes of toroidal and poloidal magnetic field. In particular embodiments, the blanket wall of the combustion chamber comprises a combustion chamber-proximal shield layer and a blanket layer comprising channels suitably configured to provide for conveyance of a particle absorbing blanket fluid to provide for capturing of plasma-derived particles and/or heat flux emitted from the combustion chamber. In preferred aspects, the moveable compression member comprises means (e.g., blanket and/or shield means) for capturing neutrons and protecting the compression member coil(s) therefrom.

Additionally provided is a device for compression of a compact toroidal plasma (spheromak) for fusion-mediated neutron generation, comprising: a variable-volume plasma combustion chamber defined by a blanket wall and a movable compression member surface, the combustion chamber comprising a divertor opening, the combustion chamber blanket wall comprising a combustion chamber-proximal shield layer and a blanket layer comprising at least one channel suitably configured to provide for conveyance of a neutron absorbing blanket fluid to provide for capturing of plasma-derived neutron flux emitted from the combustion chamber; a divertor portion having a divertor chamber in flow communication with the combustion chamber via the divertor opening; spheromak plasma formation and injecting means in communication with the combustion chamber, the formation and injecting means suitable for generating and injecting a quasi-steady state spheromak plasma into the combustion chamber; a plurality of magnetic field coils, positioned outside the blanket wall and suitably configured to provide for a magnetic well within the combustion chamber, the magnetic well suitable for magnetically isolating the spheromak plasma from the blanket wall of the combustion chamber; a moveable compression member having at least one compression member magnetic field coil, the compression member and field coil(s) moveable to vary the volume within the compression chamber, the compression member magnetic field coil suitably configured to provide for magnetic isolation of the spheromak plasma from the compression member surface; and compression member positioning means suitable, in operation with the compression member and compression member field coil, to provide for cycled positioning of the compression member to provide for cycled compression and decompression of plasma within the compression chamber. Preferably, the plasma formation and injecting means comprises a pair of spaced annular parallel formation electrodes, suitably configured for generating and injecting magnetized compact toroidal plasma into the combustion chamber, and the moveable-member comprises at least one piston, each having at least one attached or integral magnetic field coil. Certain piston embodiments comprise a cam and a cam follower, the cam follower in operative communication between the cam and the piston to provide for cycled positioning of the piston within the combustion chamber. In particular aspects, the diverting chamber is defined by at least one divertor blanket wall and at least one divertor target surface suitably configured to receive hot particles from the combustion chamber, and the divertor comprises a plurality of divertor magnetic field coils, and at least one exhaust gas port. Preferably, the divetor comprises a divertor shielding plug having a blanket wall, the diverter shielding plug and blanket wall suitably configured to shield the internal diverter chamber surfaces from particle bombardment from the combustion chamber. In preferred aspects, the spheromak plasma comprises a quasi-steady state spheromak plasma having approximately equal magnitudes of toroidal and poloidal magnetic field. Preferably, the device comprises blanket means for converting the incident neutron flux to thermal energy to be captured in a steam cycle. In certain embodiments, the moveable compression member comprises means (e.g., blanket and/or shield means) for capturing neutrons and protecting the compression member coil(s) therefrom. Particular implementations comprise a particle beam configured to intersect said toroidal plasma to provide for maintaining current profiles during the compression phase.

Further provided is a spheromak-compression fusion reactor for fusion-mediated neutron generation, comprising: a variable-volume spheromak plasma combustion chamber defined by a blanket wall and a movable compression member surface, the combustion chamber comprising a divertor opening, the combustion chamber blanket wall comprising a combustion chamber-proximal shield layer and a blanket layer comprising at least one channel suitably configured to provide for conveyance of a neutron absorbing blanket fluid to provide for capturing of plasma-derived neutron flux emitted from the combustion chamber; a divertor portion having a divertor chamber in flow communication with the combustion chamber via the divertor opening, the diverting chamber defined by at least one divertor blanket wall and at least one divertor target surface suitably configured to receive hot particles from the combustion chamber, and wherein the divertor comprises a plurality of divertor magnetic field coils, and at least one exhaust gas port; spheromak plasma formation and injecting means in communication with the combustion chamber and comprising a pair of spaced annular parallel formation electrodes, suitably configured for generating and injecting a quasi-steady state magnetized compact toroidal plasma into the combustion chamber; a plurality of magnetic field coils, positioned outside the blanket wall and suitably configured to provide for a magnetic well within the combustion chamber, the magnetic well suitable for magnetically isolating the spheromak plasma from the blanket wall of the combustion chamber; a moveable compression member having at least one compression member magnetic field coil, the compression member and field coil(s) moveable to vary the volume within the compression chamber, the compression member magnetic field coil suitably configured to provide for magnetic isolation of the spheromak plasma from the compression member surface; and compression member positioning means suitable, in operation with the compression member and compression member field coil, to provide for cycled positioning of the compression member to provide for cycled compression and decompression of plasma within the compression chamber. In certain aspects, the moveable-member comprises at least one piston, each having at least one attached or integral magnetic field coil. Particular piston implementations comprise a cam and a cam follower, the cam follower in operative communication between the cam and the piston to provide for cycled positioning of the piston within the combustion chamber. Preferably, the divetor comprises a divertor shielding plug having a blanket wall, the diverter shielding plug and blanket wall suitably configured to shield the internal diverter chamber surfaces from particle bombardment from the combustion chamber. In preferred aspects, the spheromak plasma comprises a quasi-steady state spheromak plasma having approximately equal magnitudes of toroidal and poloidal magnetic field. Particular embodiments, comprise means for converting the incident neutron flux to thermal energy to be captured in a steam cycle. Preferably, the moveable compression member comprises means (e.g., blanket and/or shield means) for capturing neutrons and protecting the compression member coil(s) therefrom. Certain embodiments comprise a particle beam configured to intersect said toroidal plasma to provide for maintaining current profiles during the compression phase. Preferred implementations are configured to provide power for terrestrial distributed power applications, preferably in the 10 to 100MW range. Certain embodiments are configured to provide propulsion of terrestrial and ocean-going vehicles.

Yet additionally provide is an electrode apparatus for generating and releasing a spheromak, comprising: a pair of spaced annular parallel electrodes defining an annular inter-electrode gap therebetween and radially-inward and radially-outward gap openings, the radially inward gap opening providing an open annular breech for release of toroidal plasma formable within the annular inter-electrode gap; a solenoid member and vacuum means suitably configured for generating a vacuum magnetic field in the annular inter-electrode gap, the solenoid member positioned to seal the radially outward gap opening; a gas inlet and valve means for introducing gas into the annular inter-electrode gap; capacitor or DC electrical power supply means in electrical communication with the annular parallel electrodes and configured to be dischargable thereto to provide for breakdown of a gas in the annular gap to form a magnetized toroidal plasma (spheromak); and a plurality of magnetic field coils positioned external to the inter-electrode gap and suitably configured to establish magnetic flux linking both annular parallel formation electrodes within the inter-electrode gap for maintaining equilibrium and stability of the plasma configuration, wherein the solenoid, capacitor or DC electrical power means, gas inlet, breech opening and external magnetic field coils are operative with the annular parallel electrodes to provide for generating and releasing a spheromak. Certain aspects, further comprise means for producing pulsed formation and release of magnetized plasma. Particular aspects further comprise a vacuum vessel. Preferably, the annular parallel electrodes are coated with a material having sufficient refractory properties to protect said electrodes from damage by heat loading. More preferably, the annular parallel electrodes comprise tungsten-coated OFHC copper electrodes.

Yet further embodiments provide an electrode apparatus for refluxing a quasi-steady state spheromak, comprising: a plasma chamber magnetically configurable to provide a magnetic well therein sufficient for magnetic containment of a quasi-steady state spheromak; a pair of spaced annular parallel electrodes defining an annular inter-electrode gap therebetween and radially-inward and radially-outward gap openings, the radially inward gap opening providing an open annular breech for release of toroidal plasma formable within the annular inter-electrode gap, the open annular breech operatively coupled to the magnetic well of the plasma chamber; a solenoid member and vacuum means suitably configured for generating a vacuum magnetic field in the annular inter-electrode gap, the solenoid member positioned to seal the radially outward gap opening; a gas inlet and valve means for introducing gas into the annular inter-electrode gap; capacitor or DC electrical power supply means in electrical communication with the annular parallel electrodes and configured to be pulse dischargable thereto to provide for breakdown of a gas in the annular gap to form a magnetized toroidal plasma (spheromak); and a plurality of magnetic field coils positioned external to the inter-electrode gap and suitably configured to establish magnetic flux linking both annular parallel formation electrodes within the inter-electrode gap for maintaining equilibrium and stability of the plasma configuration, wherein the solenoid, capacitor or DC electrical power means, gas inlet, and external magnetic field coils are operative with the annular parallel electrodes, breech opening and magnetic well to provide for pulsed injection of magnetic helicity to form and reflux a quasi-steady state spheromak within the magnetic well of the plasma chamber. Particular aspects further comprise a vacuum vessel. Preferably, the annular parallel electrodes are coated with a material having sufficient refractory properties to protect said electrodes from damage by heat loading. More preferably, the annular parallel electrodes comprise tungsten-coated OFHC copper electrodes. In certain embodiments, magnetically configuring the plasma chamber to provide a magnetic well therein sufficient for magnetic containment of a quasi-steady state spheromak comprises use of a set of externally mounted poloidal field coils and a conducting layer mounted inside a blanket module having sufficient conductivity to establish eddy currents.

Additionally provided are methods for producing a quasi-steady-state spheromak using the above described devices and electrodes.

Particular aspects provide a method for compression of a magnetized plasma, compact plasma or spheromak, comprising: providing a magnetized plasma, compact plasma or spheromak in a magnetic well of a plasma compression or combustion chamber; and compressing the plasma or spheromak using a moveable compression member having at least one compression member magnetic field coil, the compression member and field coil moveable to vary the volume within the compression or combustion chamber to provide for cycled compression and decompression of plasma within the compression chamber.

Additional aspects provide a method for compression of a magnetized plasma, compact plasma or spheromak for fusion-mediated neutron generation, comprising: providing a magnetized plasma, compact plasma or spheromak in a magnetic well of a plasma compression or combustion chamber; and compressing the plasma or spheromak to achieve ignition of a fusion regime using a moveable compression member having at least one compression member magnetic field coil, the compression member and field coil moveable to vary the volume within the compression or combustion chamber to provide for cycled compression and decompression of plasma within the compression chamber.

Further aspects provide a method of compressing a spheromak to provide a fusion reactor, comprising: providing a spheromak plasma in a magnetic well of a plasma compression or combustion chamber, the chamber operatively coupled to at least one of a direct energy convertor and a blanket layer comprising at least one channel suitably configured to provide for conveyance of a particle absorbing blanket fluid to provide for capturing of plasma-derived particle flux emitted from the combustion chamber; compressing the spheromak plasma to achieve ignition of a fusion regime using a moveable compression member having at least one compression member magnetic field coil, the compression member and field coil moveable to vary the volume within the compression or combustion chamber to provide for cycled compression and decompression of the plasma within the compression chamber; and capturing plasma-derived energy or particle flux emitted from the combustion chamber.

In preferred method aspects, the spheromak comprises a quasi-steady-state spheromak, and the fusion regime provides neutrons that are captured within the blanket medium of the combustion chamber. Preferably, the quasi-steady-state spheromak is derived from a mixture of deuterium and tritium.

In particular aspects, the spheromak plasma is derived from at least one fuel selected from the group consisting of neutronic fuels, aneutronic fuels, deuterium-trirtium (D-T), deuterium-deuterium (D-D), proton-boron-11 (p-B11), and deuterium-helium-3 (D-He3).

Additionally provided are methods for producing a quasi-steady-state spheromak using annular parallel magnetized electrodes for generating a poloidal magnetic field, electrical input means for said electrodes providing particle species for a discharge between said electrodes, and an open annular breech for the passage of a resulting compact toroidal plasma, the method comprising: flowing a particle species between said electrodes of sufficient quantity for creating a plasma upon application of predetermined repeatedly pulsed discharge currents; and forming a toroidal plasma by discharging an electrical energy storage means across said electrodes.

Further provided are methods for compressing a quasi-steady-state spheromak to ignition, comprising use of a mechanically actuated moveable member or piston comprising a means for capturing neutrons and protecting the coils contained in the piston, wherein the method comprises: energizing a cam, using energy from an electrical source, to set a follower and piston in motion with velocity sufficient for compression of a spheromak plasma; magnetically isolating the spheromak plasma from the piston surface by use of coils mounted internally to the piston head; increasing current to the piston coil during compression to provide for continuous isolation of the plasma from the piston surface during compression; wherein the cam is configured to provide for a sufficient compression and period to provide for plasma ignition and burning, and wherein the piston can be optionally backed-off or positionally adjusted.

Yet further aspects provide methods for producing a loss of core confinement from a spheromak, comprising: cooling of outer surfaces of a plasma by expanding the plasma to alter the current profile, wherein the q=½ mode rational surface enters the plasma; applying a finite error field by use of an externally mounted coil providing for exciting a 2/4 island mode in the plasma within a combustion chamber; and pumping of helium ash from the combustion chamber.

These and other objects, features and advantages of the invention will become apparent from the following description of the embodiments of the invention taken in conjunction with the accompanying drawings.

### BRIEF DESCRIPTION OF THE DRAWINGS

FIG. 1a shows, according to exemplary aspects, a partial cross section of one embodiment of a plasma compression device.

FIG. 1b shows, according to exemplary aspects, an isometric view of the partial cross section of FIG. 1a.

FIG. 2 shows, according to exemplary aspects, a partial cross section detail of a combustion chamber.

FIG. 3 shows, according to exemplary aspects, a detailed cross section of the annular parallel formation electrodes.

FIG. 4 shows, according to exemplary aspects, a cross-section of the plasma in the combustion chamber showing magnetic flux contours and the spheromak plasma in equilibrium supported by the equilibrium coils.

FIG. 5 shows, according to exemplary aspects, a detailed partial cross section of the divertor mounted on top of the combustion chamber.

FIG. 6 shows, according to exemplary aspects, a schematic of a radial build of a first wall, blanket, stability layer, RWM coils, shield and coils.

FIG. 7 shows, according to exemplary aspects, a schematic of tritium-handling, processing and fueling subsystems.

FIG. 8 shows, according to exemplary aspects, an exemplary embodiment of a site plan for a plasma compression reactor.

FIGS. 9A-H show, according to exemplary aspects, a schematic of the stages of the inventive compression cycle (Woodruff Cycle): A) formation of the plasma by injection from the electrodes; B) begin movement of the piston to compress plasma; C) peak compression; D) slow compression to maintain constant P; E) continuation of compression for q-profile control and fueling; F) expansion of the plasma; G) reflux by injection from electrodes; and H) merging and reconnection.

FIG. 10a shows, according to exemplary aspects, a schematic P-V diagram for the compression cycle (Woodruff Cycle).

FIG. 11a shows, according to exemplary aspects, the magnetic field profiles at full expansion (upper left panel) and at full compression (upper right panel).

FIG. 11b shows, according to exemplary aspects, the toroidal flux surfaces at full expansion (lower left panel) and at full compression (lower right panel).

FIGS. 12 A-F show, according to exemplary aspects, a schematic time-history of dominant macroscopic parameters during a single compression cycle of: a) the gun voltage; b) total magnetic helicity; c) toroidal current in the plasma; d) temperature; e) density; and f) is a plot of the triple product nTtau.

FIG. 13 shows, according to exemplary aspects, an energy flow diagram for the compression cycle showing output power and recirculating power.

FIG. 14a shows, according to exemplary aspects, the density profiles at full expansion (upper left panel) and at peak compression (upper right panel), and the temperature profiles at full expansion (lower left panel) and at peak compression (lower right panel).

FIG. 14b shows, according to exemplary aspects, the plasma beta as a function of radius (upper panel) and fusion power as a function of the minor radius (lower panel) for the compressed state for plasmas with β=0.05, 0.1 and 0.2.

### DETAILED DESCRIPTION

Overview. Provided are methods and devices for compression of a spheromak plasma (e.g., derived from at least one of neutronic fuels, aneutronic fuels, deuterium-trirtium (D-T), deuterium-deuterium (D-D), proton-boron-11 (p-B11), and deuterium-helium-3 (D-He3)) in a magnetic well configured within a plasma combustion chamber using an induction coil axially adjacent to the plasma, wherein a moveable member (e.g., piston, cam and follower) drives the induction coil toward the plasma, pushing the plasma via magnetic pressure into the magnetic well and compressing the plasma substantially adiabatically (e.g., coil motion is well below the plasma sound speed). The compression quickly increases both plasma density and temperature past the point of ignition, and after plasma burn, the coil is backed-off to allow the plasma to re-expand, providing for refueling and repetition of the compression cycle. Additionally provided are spaced annular plasma formation electrodes, suitably configured for generating and injecting magnetized plasma into a plasma combustion chamber. Preferably, spaced annular plasma formation electrodes are used in combination with moveable compression members as disclosed herein.

### Plasma Compression Device 101

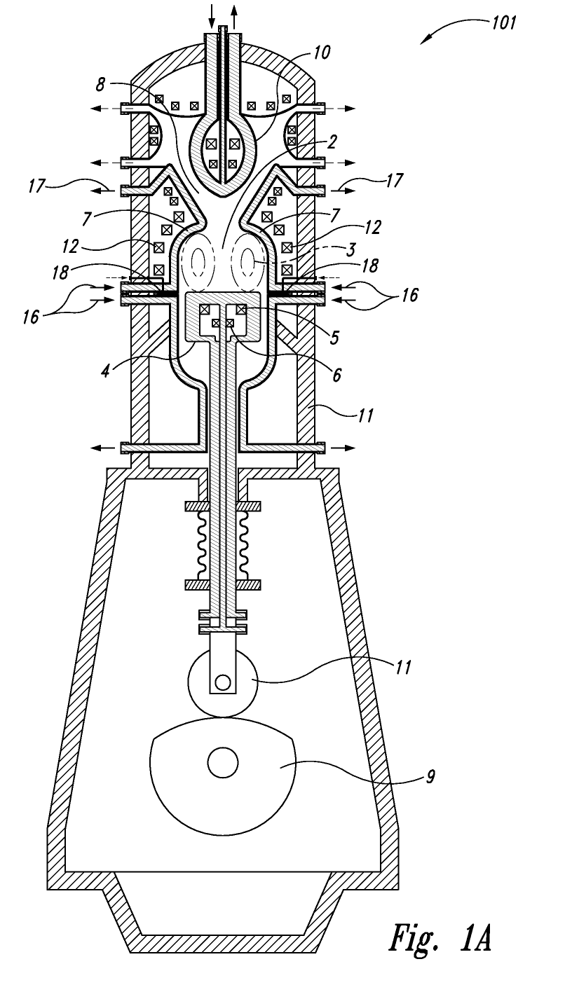

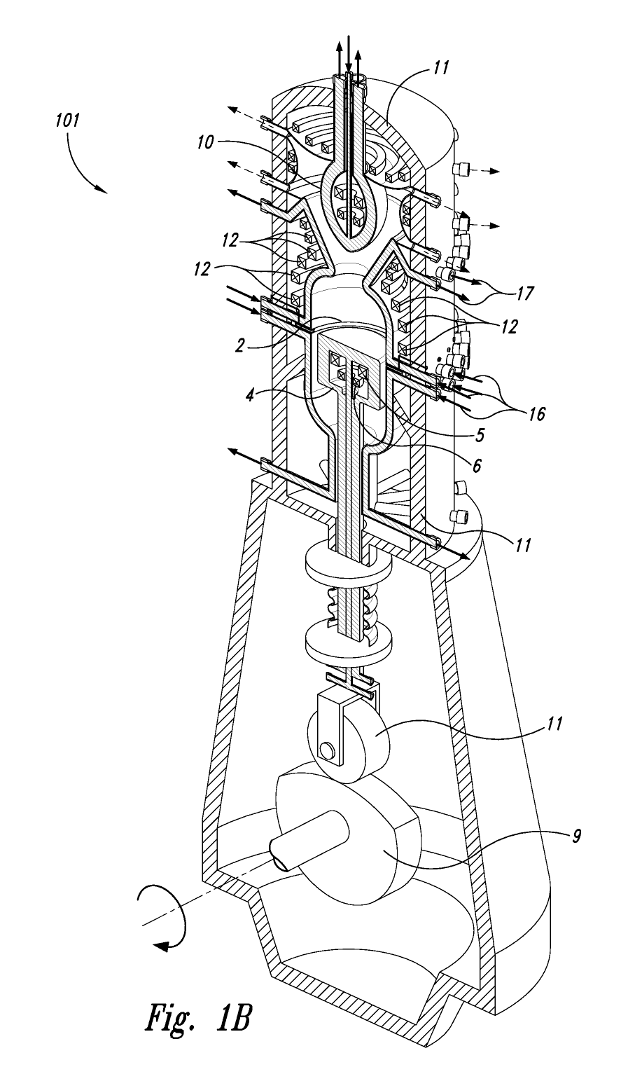

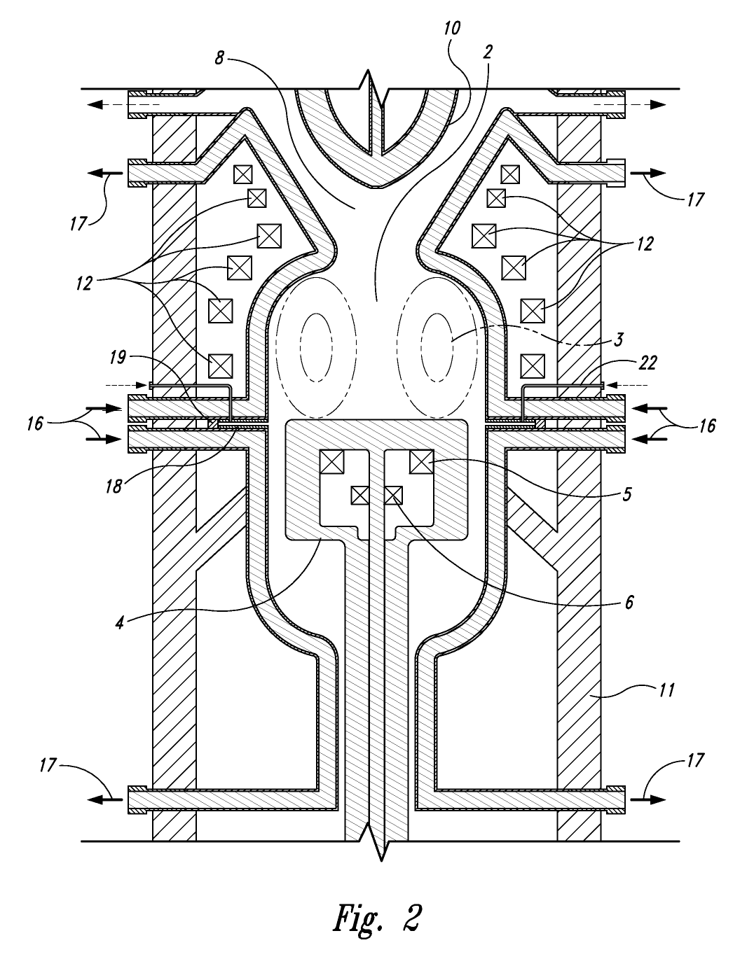

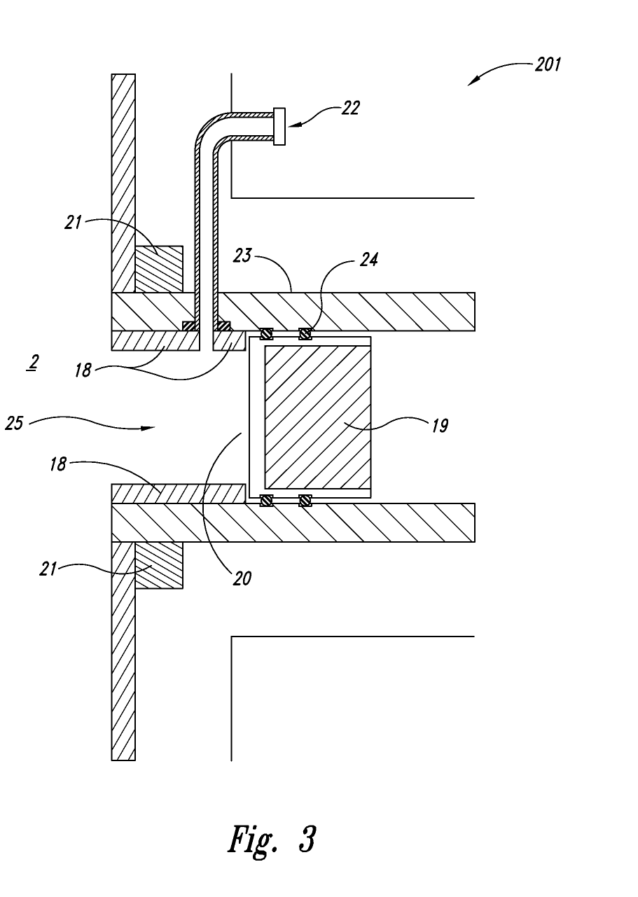

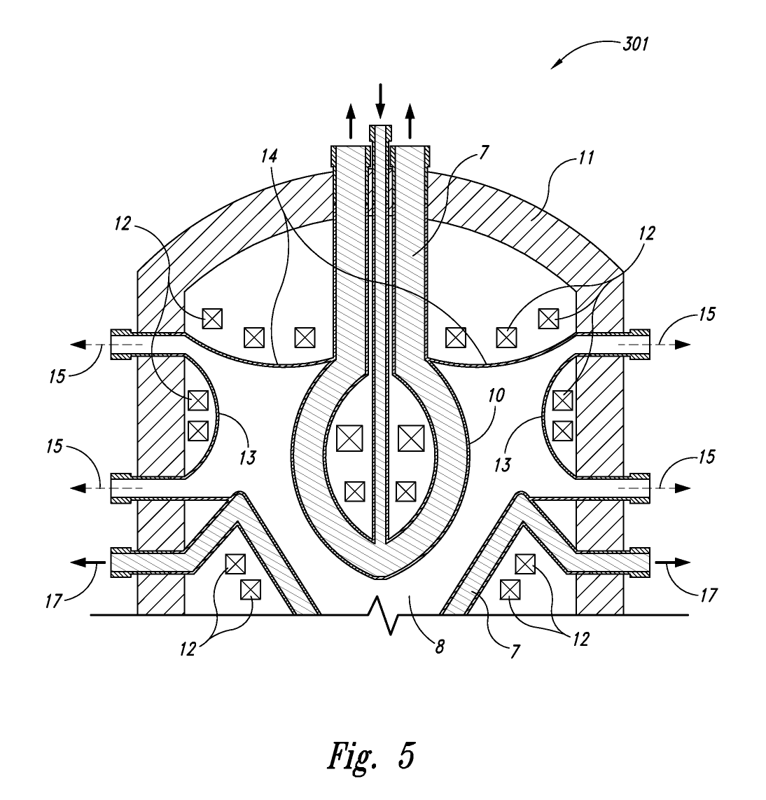

FIGS. 1-4 show, according to particular aspects, an exemplary plasma compression device, comprising the following elements: piston 4, cam 9 and cam follower 11 (FIGS. 1a and 1b); simply connected combustion chamber 2 (FIG. 1a, and FIG. 2); compact toroidal plasma and equilibrium coils 12 (FIG. 2); annular formation electrode system 201 with electrodes 18 for formation and refueling of plasma (FIG. 3); blanket 7 for capturing neutrons (FIG. 2); and divertor 301 with divertor chamber 8 (FIG. 5), which are described in more detail in this section.

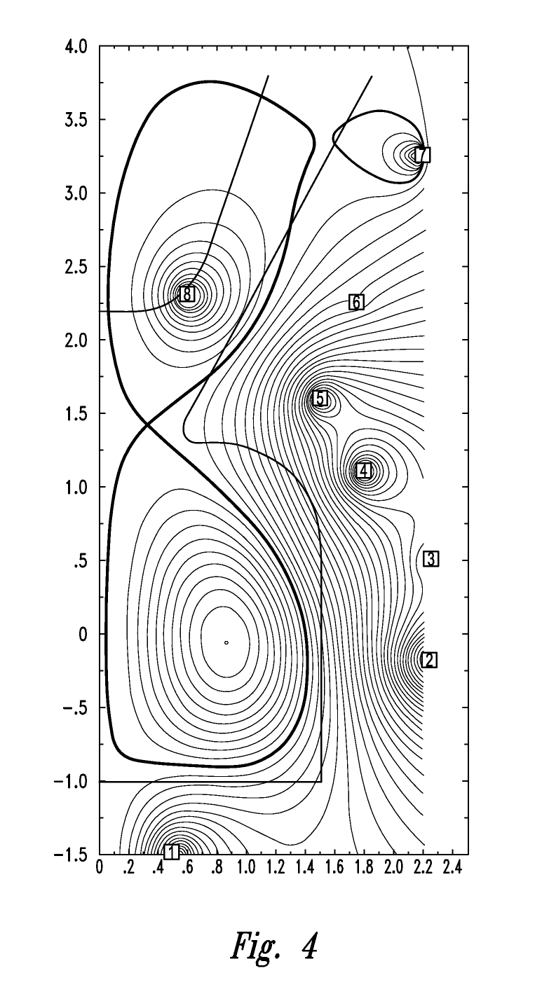

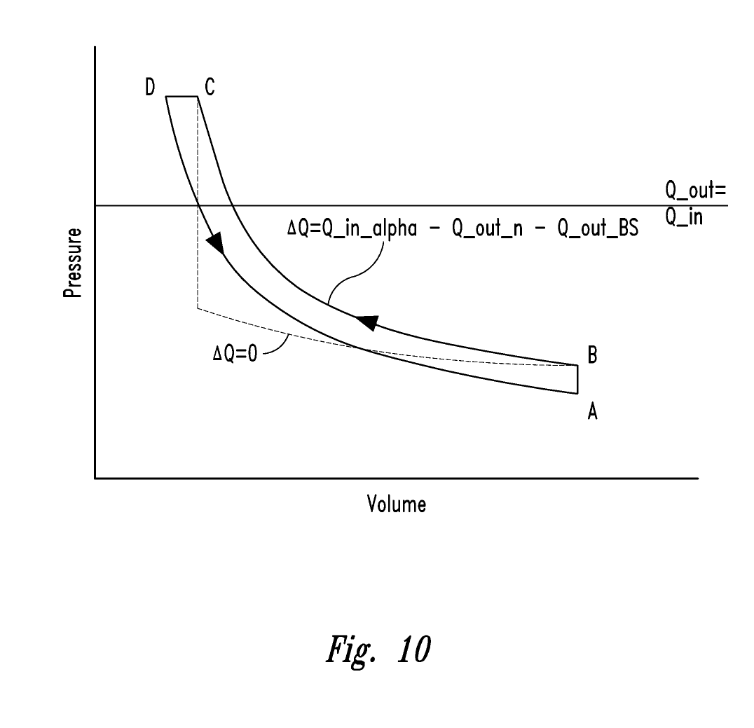

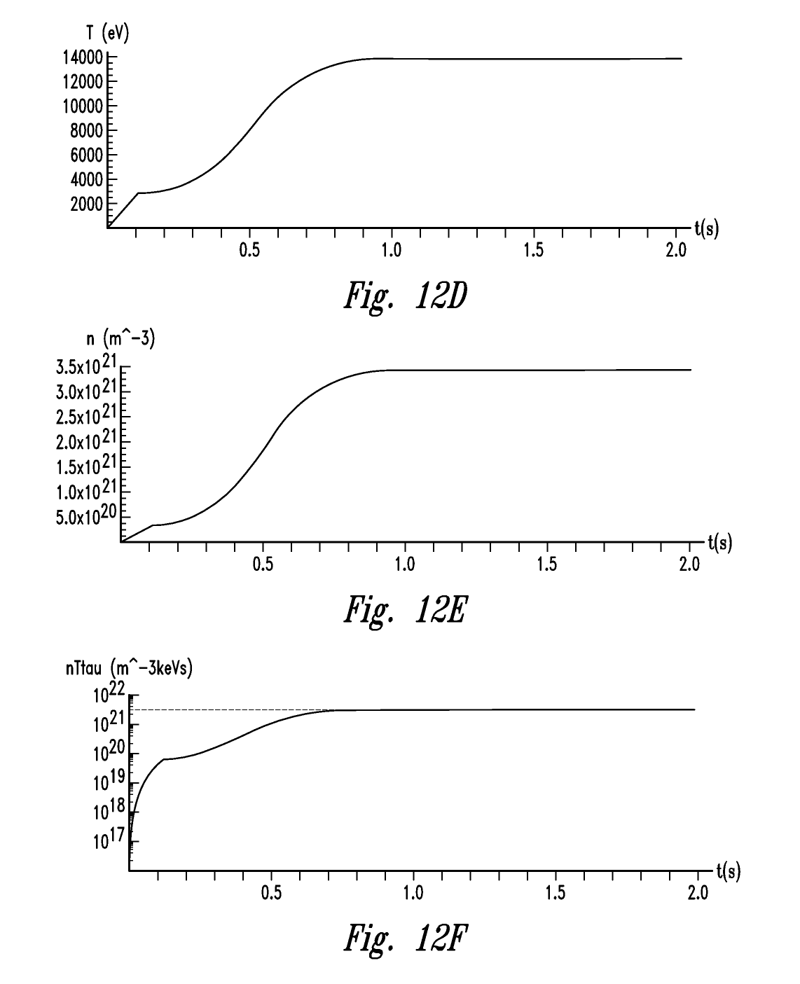

Turning now to FIGS. 1a, 2 and 4, the plasma discharge begins when the piston head 4 is at full retraction: deuterium and tritium gas are injected between parallel annular electrodes 18 and a voltage applied to those electrodes forms a deuterium and tritium plasma 1 between the electrodes 18. Toroidal magnetized plasma 3 is injected into the combustion chamber 2, and is trapped there. A rotating cam 9 then pushes the follower 11 and drives the piston 4 down the combustion chamber 2 to compress the plasma 3. In operation, the fields generated by the attached magnetic field coils 5 and 6 are suitably configured to isolate the compact toroidal plasma 3 from the piston 4. The moving piston 4 with magnetic isolation from the coils 5 and 6 drives the plasma 3 into a magnetic well (upper portion of combustion chamber 2) generated by the equilibrium coils 12 mounted behind the blanket and shield 7. The compact toroidal plasma 3 is compressed into a smaller but similar geometry (see FIGS. 4 and 12), in which the major radius (R) and minor radius (a) of the toroid are scaled in proportion to each other, preserving aspect ratio A=R/α. With a radial convergence (C=αᵢₙᵢₜᵢₐₗ/α_{final}2.5), the plasma can reach the Lawson criterion for an ignited fusion reaction (see FIG. 10), in which heating from alpha particles matches the losses due to Bremsstrahlung radiation. The fusion reaction produces either energetic neutrons that can heat the blanket fluid in blanket 7, or energetic particles can pass into the divertor chamber 8 where heat is recovered usefully, for example, in a steam cycle to drive a turbine to produce power.

### Moveable Mechanical Member

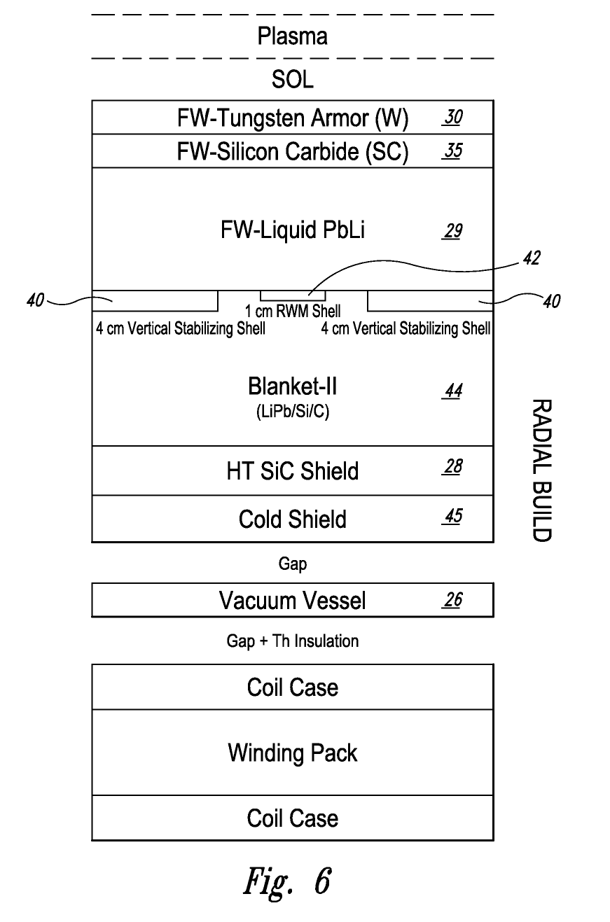

According to particular aspects, a moveable member is used to position attached magnetic field coils 5 and 6 in relation to the plasma 3 during plasma generation and compression. In particular aspects, and turning to FIG. 1, the moveable member comprises a piston 4 (comprising a head and a shaft), which is configured to be in operative communication with a force/energy transmission means (e.g., cam 9 and cam follower 11) (e.g., built from steel, or other suitable materials), to provide for piston actuation. The cam 9 shape is chosen to give a relatively long compression time and short expansion time (e.g., giving a ‘duty cycle’ of 0.9, although a wide range of duty-cycles are possible by choice of cam design), and the forces for the cycle are constrained within the material stress limits (e.g., for steel), for example, as per other existing large diesel engines (e.g. in the RTA96-C, the maximum bearing loading is chosen to be less than 10MNewtons). Also much like in existing large bore engines, piston head coolant flows along the shaft of the piston to be recirculated down the piston shaft. In particular aspects, blanket coolant is pumped into and out of the piston at the base of the follower 11. As per other first wall components, the piston head surface is preferably armored with plates (e.g., tungsten plates), and has a similar radial build to that shown in FIG. 6. Follower 11 rides on the cam 9 with heavy oil lubricant, collected in the sump. A vacuum boundary is maintained between the combustion chamber and the cam chamber by use of a flexible steel bellows.

Alternative exemplary embodiments of the exemplary piston and cam configuration may comprise a solenoid actuation instead of a cam-follower in which energy is recovered from the compressed plasma by induction of currents in solenoidal coils. The spatial arrangement of the system could also be varied, to be, for example, arranged in the horizontal, or inverted to have an overhead cam with a slot arrangement for the piston follower. Other embodiments with shorter compression periods are possible, which include a double ended opposing cylinder (or free-piston) configurations. As will be evident to one of ordinary skill in the art any suitable moveable member suitably configured to be in operative communication with a force/energy transmission means and having magnetic isolation means may be used to position attached the coils (e.g., coils 5 and 6) to drives the plasma 3 into a magnetic well.

### Combustion Chamber

FIG. 2 shows the detail of an exemplary combustion chamber 2. Coil and vacuum chamber loads are taken by an external cylindrical structure (the hashed external vessel—forms the dome at the top) (e.g., steel) with internal radial struts. Blanket fluid is pumped through inlet 16 and out along tubes that run axially and radially (and parallel to the magnetic field) to outlets 17. Blanket 7 components are designed to align parallel to the applied magnetic field from the equilibrium field coils 12 so that the blanket fluid pumping power can be minimized.

Significantly, using magnetic field coils 5, 6 and 12, the combustion chamber 2 is magnetically configurable to provide a magnetic well therein sufficient for magnetic containment of a quasi-steady state spheromak during formation and compression as disclosed herein.

Alternate exemplary embodiments of the combustion chamber comprise omission of the lower blanket section (e.g. below the piston head) which catches only a small fraction of the emitted neutrons. Additional exemplary embodiments comprise a cylindrical chamber with divertor plug 10 (see FIG. 5) of same geometry as the piston 4, providing however along its sides a wider gap for the passage of exhaust gases to the divertor. Yet further exemplary embodiments comprise the use of an aneutronic fuel, to provide for omission or reduction of the blanket and/or shield (see discussed below).

### Annular Formation Electrode System 201

FIG. 3 shows, according to particular aspects, details of an annular parallel formation electrode system 201 suitable for generation of magnetized toroidal plasma. Components of the electrode system comprise a solenoid 19, bucking coils 21, coated electrodes 18 (e.g., tungsten-coated OFHC copper electrodes), vacuum vessel 23, and one or more gas entry ports 22. The vacuum is sealed by mating the coil form 19 to the vacuum vessel 23, for example, with an electrically isolating seal 24 comprising one or more high temperature insulating gaskets made of suitable material (e.g., viton rubber) and preferably wherein the inner surface of the coil form 19 is plasma sprayed with alumina to provide electrical isolation between the electrodes.

Using the parallel formation electrode system, the formation of magnetized plasma is initiated by first energizing the solenoid 19 and bucking coils 21 to establish magnetic flux that links both annular parallel formation electrodes in the inter-electrode gap 25 but does not enter the combustion chamber 2. The inter-electrode gap spacing is typically no more than ⅓ of the plasma minor radius, though can be as small as 1/10 the minor radius. Gas (e.g., deuterium and tritium, or other suitable gas) is then introduced into the gap 25 via the gas entry port 22 by opening a valve (e.g., puff valve attached to the end of the gas inlet tube). As gas enters the gap 25, suitably charged capacitor banks are discharged to the annular parallel formation electrodes

Iₜₕᵣₑₛₕ=4ψ_{gun}/Δμ₀

to produce a breakdown in the gas and form a magnetized plasma. For example, in order to produce a I=1 MAmpere current pulse in t=50 microsceonds, a total charge of It=50 Coulombs is needed. A capacitor bank of maximum charge of V=15 kV (to avoid breakdown in air), and energy E=QV=0.7 million Joules, is then needed, which is a modest sized bank. As the current from the capacitor banks increases, a threshold (determined by the ratio of the electrode current to magnetic flux linking the electrodes and the gap spacing, Δ: with unit of amperes) is reached at which point the magnetized plasma is not constrained to flow between the electrodes, and self-forces push the plasma from the gap 25 into the combustion chamber 2.

In particular aspects, to increase the toroidal current in the plasma, the electrodes 18 are energized (and de-energized) in a repeated fashion, each time adding a complete toroidal plasma to the toroidal plasma held in equilibrium in the combustion chamber 2. The total power and total current density on the annular parallel formation electrodes is kept below particular limits set by the melting temperature of (the electrode coating material), for example, tungsten and the ion saturation current, which ensures that the electrodes are not damaged during formation. As appreciated in the art, such limits are typically encountered in electrode systems, and are mitigated by lowering the current density below operating limits. In the instant exemplary case, this is achieved by an increase of electrode surface area of about an order of magnitude over prior art systems operating at the power limit of about 5MW/m². Such pulsed start-up techniques are used to initiate spheromak plasmas routinely to achieve mega-ampere plasma currents.

In particular embodiments, the annular parallel formation electrodes 18 are connected to capacitor bank modules containing high current spark-gap switches, electrolytic capacitors, high current diodes and low inductance transmission-line cables. In certain aspects, each pulse requires a separate module, and up to 10 modules or more, for example, are used to generate approximately 7 million Amperes of current in the spheromak for operation of the device as a neutron source of fusion reactor. In certain aspects at least 7 million Amperes of current is required in the spheromak for operation of the device as a neutron source or fusion reactor.

In particular aspects the spaced annular electrodes are parallel or substantially parallel. In alternative embodiments at least one of the annular electrodes is angled to provide a larger gap at the outer or inner gap opening. In certain embodiments both annular electrodes are angled to provide differential inner and outer gap openings. According to particular aspects such angled configurations provide for further modulation of plasma formation in and/or release from the inter-electrode gap. Moreover, annular electrodes angled either parallel, directed towards the confinement chamber, or angled, so that the wider portion is located closest to the confinement chamber are encompassed. Yet further embodiments provide for a narrower gap close to the magnetic field coil, and wider parallel gap closer to the confinement chamber, where the latter configuration allows for a magnetic reconnection of the plasma in the gun prior to the reconnection in the chamber. Additional embodiments provide spaced annular electrodes having a differential radial diameter. According to particular aspects such differential configurations provide for further modulation of plasma formation in and/or release from the inter-electrode gap.

As will be appreciated by one of skill in the art, other configurations of formation electrodes may be employed to generate the magnetized plasma. For example, coaxial electrodes mounted on the side of the piston head 4 and on the inner surface of the first wall that are energizable at full retraction of the piston head may be used to inject magnetized plasma into the combustion chamber. In further alternate embodiments, injection from the divertor portion/region 301 (FIG. 5) is also possible by energizing the divertor plates 13, 14, as is done in the art for tokamak plasmas.

### Configuring Compact Plasma as Spheromaks within the Combustion Chamber

According to particular aspects, FIG. 4 shows a cross-section of a preferred compact plasma configuration enclosed in the combustion chamber being held in isolation from the walls of the chamber 2 and in stable equilibrium by externally imposed magnetic fields, prior to compression. Equilibrium coils, labeled 1 through 8, are shown with coil 1 being in the piston head 4 and coil 8 being in the divertor plug 10, with the compact plasma configuration therebetween in the magnetic well of the combustion chamber. Also shown are the first wall outline and contours of poloidal flux, forming two regions: closed flux in the compact plasma configuration; and open flux around the perimeter of the compact plasma and intersecting the divertor surfaces referred to in the art as a scrape-off-layer. Additionally labeled are the magnetic axis and geometric axis. This type of plasma configuration is referred to in the art as a “spheromak” with approximately equal magnitudes of toroidal and poloidal magnetic field. The spheromak differs from the tokamak in that there is no material linking the toroidal plasma, and so stabilizing magnetic fields are provided in the plasma itself, making the configuration much simpler and compact. A review of spheromak research from the last 20 years was produced recently (S. Woodruff Technical Survey of Simply Connected Compact Tori (CTs): Spheromaks, FRCs and Compression Schemes Journal of Fusion Energy, Volume 27, Numbers 1-2/June, 2008; incorporated by reference herein for its referenced teachings), giving data and discussion of existing devices that show, inter alia: the formation by electrodes of plasma currents of >1 million Amperes; confinement properties similar to tokamaks of the same dimensions; higher pressure limits than tokamaks, set by the Mercier condition; macroscopic stability (tilt, shift, low order mode-rational surfaces); expected density scaling with magnetic field constrained by the Greenwald limit, and heating by compression. Measurements in spheromaks show that the temperature and density vary in direct proportion to the poloidal flux, and experiments show that perpendicular heat losses are in the range of 1-10 m² s⁻¹, very much like tokamaks. Strong toroidal rotation is observed in spheromaks, together with reversed shear in the magnetic field and observation of steep internal temperature gradients indicating conditions for internal transport barrier formation and hence H-mode confinement. Measurements in spheromaks show that the core electron beta (ratio of the plasma to magnetic field pressure) can exceed 5% at the magnetic axis, and experimental results show that the pressure limit is set by the Mercier condition in long-lived plasmas, but can also be exceeded transiently (see for example F. J. Wysocki, et. al., Phys. Rev. Lett. 61, 2457 (1988))).

The spheromak plasma once formed by the plasma formation electrodes will be compressed when the q-profile spans the range from 0.5<q<0.66, so excluding the ⅔ and ½ modes from the plasma. Results from prior experiments show that this is a preferred operational point, giving the maximum beta and therefore highest temperatures for a given magnetic field strength, and best confinement due to absence of magnetic islands that short-circuit the radial transport. The q-profile evolution is determined by the resistive decay time of the plasma which is set by the plasma resistivity. According to particular inventive embodiments, this evolution time is 200 seconds with a core electron temperature of 10 keV, possibly shorter with lower electron temperatures, and so the plasma is preferably refluxed by injection from electrodes on a time-scale short compared to the decay time; for example: injection every minute. This time sets most of the major parameters for the system, including of course the cam rotation speed (e.g., 1 rpm, for injection every minute).

Other possible ratios of the poloidal to toroidal magnetic field (q-profile) operating points are encompassed within the scope of the invention. For example, operation between the mode rational surfaces of ⅔ (q=0.66) and ⅘ (q=0.8) is possible, although this means that the shear in the q-profile is quite shallow (dq/dr=0.14/1.5 instead of 0.16/1.5), and may limit the obtainable beta. According to additional aspects, a further operating point is obtained by allowing the q-profile to evolve to encompass the mode-rational surfaces, thereby enhancing particle transport for a controllable period to flush out helium ash that accrues in the core. This aspect is discussed further below.

### Alternate Compact Toroidal Plasma Configurations and Fuels

Other compact toroidal plasma configurations can be compressed in the disclosed device embodiments. For example, it is possible to produce by electrodes a compact toroidal configuration known in the art as the Field Reversed Configuration (FRC), which is like the spheromak configuration, although differs by virtue of completely lacking toroidal magnetic field, and rather the configuration is stabilized by highly kinetic ions.

According to further aspects, additional embodiments of the plasma configuration and combustion chamber encompass the use different fuels. Deuterium and tritium are usually considered primary candidates for fusion reactions due, when mixed in equal proportions, to the highest probability of fusion reactions occurring for a given temperature. Additional suitable fuels are based on the deuterium-deuterium (D-D) reaction, which in the primary reaction is free from neutrons (aneutronic), but at the expense raising the plasma temperature (e.g., increasing the compression in the instant case). Yet, other suitable fuels for the instant devices comprise use of the proton-boron-11 (p-B11), and deuterium-helium-3 (D-He3) fuels, which are also aneutronic. According to particular aspects, aneutronic fuels are desirable as the fusion products are charged particles which can be directly converted to electricity by replacing divertor components with a direct energy convertor. Moreover, since no neutrons are produced, the blanket and shield can be omitted entirely thereby reducing engineering complexity.

### Magnetic Field Coil Configurations

In particular aspects, art-recognized magnetic field coils of circular cross section are used to provide the magnetic field that isolates the compact toroidal plasma from the first wall and provides the scrape-off-layer. In certain implementations, these are multi-turn oxygen-free high conductivity (OFHC) copper windings that are cooled by the internal passage of a coolant such as water. To carry the expected necessary currents (e.g., of up to three million amperes), many windings are needed due to current limits in the windings of a few kilo-amperes, for particular implementations of the system under consideration, coils 1 and 8 require up to 200 windings, the other coils considerably fewer. Preferably, a high temperature multi-build insulation, such as polyimide will be used to coat each turn. In certain aspects, coils are wound onto a steel coil former to provide structural rigidity and ease of assembly as a modular unit. Expected magnetic field strengths of up to 15 Tesla are well within the material stress limits of copper alloys, as are regularly produced in the art for copper alloy and superconducting coils of more irregular geometries. According to particular aspects, the vertical shaping of the magnetic field is important for the provision of the stability of the plasma to tilting which occurs by ensuring that the ratio of the major radius to height of the plasma toroid remains the same throughout compression, and preferably remains less than 1.6 as has been demonstrated in the art for the adiabatic compression of spheromaks. The magnetic well thus generated will ensure stability to vertical displacement, or vertical or horizontal shifting of the plasma.

Alternate magnetic field coil embodiments comprise superconducting coils made of a Niobium Tin or Niobium Titanium cooled by liquid nitrogen. Superconducting coils allow for higher magnetic field strengths and are actively being developed for other fusion devices.

### Divertor Portion 301

According to particular aspects, and turning now to FIGS. 5 and 2, a divertor portion 301 comprising a divertor plug 10 and field coils (need reference numbers for these) is operatively coupled to the piston-distal end of the combustion chamber 2. FIG. 5 shows details of the divertor portion 301. The magnetic field configuration produced by the coils (need reference numbers for these) ensures that the compact toroidal plasma 3 does not directly intersect any material surfaces. Between the closed magnetic configuration and the wall (need reference numbers for the wall), there is provision of a scrape-off-layer (SOL) that transports hot particles out of the combustion chamber to the divertor target surfaces 13 and 14. According to particular aspects, the spheromak edge is in the long mean free path regime, with λ=υₜτ_{c}>L′_{∥}, where υₜ is the thermal velocity, τ_{c} the collision frequency, and L_{∥} the distance from the midplane to the divertor along the B-field. In this case, the parallel confinement time is τ_{∥}˜L_{∥}/υₜ and the perpendicular confinement time is τ⊥˜(Dₓ)²/D where Dₓ is the radial width of the SOL and D is an anomalous transport coefficient from fluctuations (1 m²/s in tokamaks, this assumes that the classical radial transport is smaller). The width/of the SOL would be Dₓ˜\sqrt{χL_{∥}/υₜ} thus, the area of the “wetted” area on the divertor (assuming no tilting of the divertor plate) is 2πRDₓ where R is the major radius. If the/exhaust power is P, then the heat flux on the divertor is S˜\sqrt{υₜ/χL_{∥}}×P/(2πR). Hot particles leaving the combustion chamber along open magnetic field lines generated by magnetic field coils 12 (see FIG. 2) are directed to intersect either one of two divertor surfaces 13, 14. Exhaust gases are then pumped out of the system through exhaust ports 15 with pumps (e.g., cryogenic pumps or turbo pumps) mounted outside the shield 99. The divertor components are shielded from neutron bombardment by a plug containing a blanket section 10. The SOL provides control of the particle inventory in the system, however the deuterium and tritium fuel ions are expected to recycle and remain in the system for many particle confinement times, leaving the plasma and being re-introduced as neutrals. While producing a higher than expected particle inventory, recycling reduces the need to refuel too regularly.

In particular aspects, the divertor portion 301 is constructed from tungsten blocks that are internally water cooled, for example using copper alloy (CuCrZr) pipes to enter and exit through each block from outside the vacuum system. Tungsten is chosen for high melting point and low sputtering yield, such that the center of the tungsten armor is readily drilled and directly brazed to the cooling tube. Such a system is known and used in the art and withstands continuous operation with incident powers (up to 25 MW/m²) well in excess of the incident power required for our system, which in particular aspects is less than 5 MW/m²) by virtue of: 1) operation of the instant system with lower power; 2) having the divertor 201 mounted outside of the combustion chamber 2; and 3) protecting divertor components from neutron bombardment by used of a divertor plug containing a blanket section 10. In certain embodiments, arrays of tungsten blocks are used to cover each divertor plate 13, 14. To further reduce the localized heat flux on the divertor plates 13, 14, the current in the DC coils 12 mounted beneath the plates are driven at low frequency (e.g., a few kHz) which sweeps the magnetic field penetration point, thereby sweeping incident heat flux across the divertor surface.

An alternate embodiment for target surfaces from the scrape-off layer comprises the use of direct energy convertors, comprising of layers of biased grids and electron collection surfaces to directly convert hot plasma flux into electricity, as appreciated in the art.

### Blanket and Shield

According to particular aspects, and turning to FIG. 6, the plasma compression device comprises blanket and shield elements (shield element being proximate to the combustion chamber) used to capture neutron and heat flux emitted by the fusing plasma. FIG. 6 shows the radial build of an exemplary blanket and shield configuration comprising two segments: an outer segment being designed as a lifetime component, thereby helping to reduce blanket waste and replacement cost; and a replaceable inner segment. On the inner segment, the first wall in the blanket model 30 is designed to withstand neutron power loading of up to 10 MW/m², has a low activation and high transparency, for which tungsten is preferably used. Typically, these components are replaced every few years, are configured to be demountable from the substructure of, for example, ferritic steel, used also as the tubes for the conveyance of, for example, a Pb-17Li blanket fluid 29. In the case of a Pb-17Li blanket fluid 29, the coolant layer 29 captures incident neutron flux and heats up from an inlet temperature of about 300 degrees to an outlet temperature of about 1000 degrees. SiC inserts 35 are used to electrically and thermally isolate the blanket fluid from the tube wall (first wall), thereby reducing eddies and increasing the maximum exit temperature from the blanket tube. Outside the first blanket layer is a 4 cm thick stabilizing shell 40 made from OFHC copper that adds stability to the plasma configuration to tilt and shift instability. Also in this layer is a 1 cm shell 42 to help stabilize resistive wall modes. A second blanket tube assembly 44 exists as the first layer of the outer (lifetime) segment; Blanket-II (e.g., LiPb/Si/C). The next blanket layer is designed as a hot shield 28. Its purpose is to absorb the remaining neutrons making it the layer with the highest activation waste. The next layer is a cold shield 45, which unlike all inner layers is designed to remain in place for the life of the power core. The final layer in the radial build is the vacuum vessel 26, preferably constructed from ferritic steel.

### Tritium Breeding System

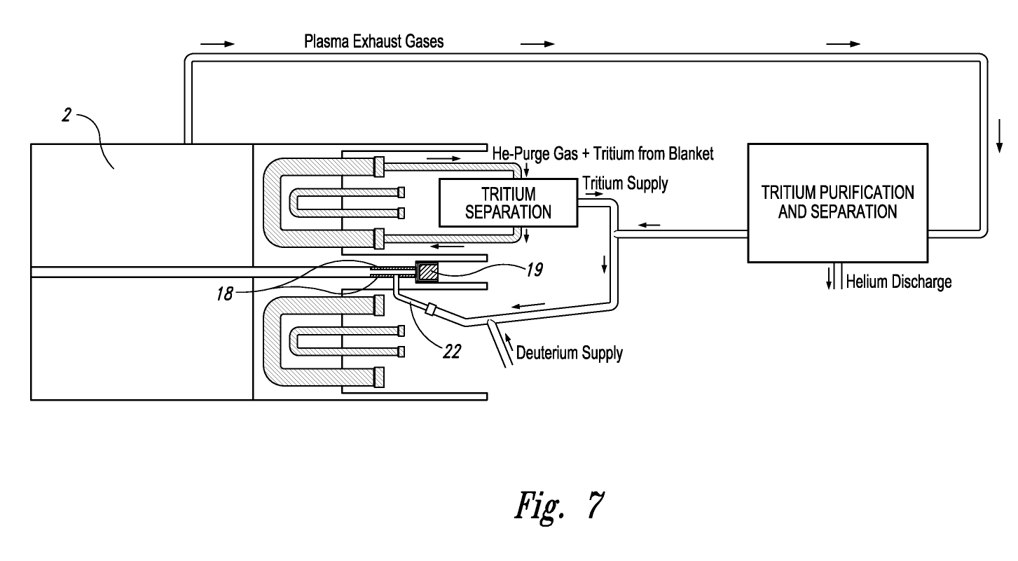

Turning now to FIG. 7, particular aspects provide a tritium breeding system. FIG. 7 shows a schematic of an exemplary tritium breeding system. Tritium is bred by injecting a lead-lithium mixture into coolant pipes that flow at the perimeter of the combustion chamber (e.g., in the Blanket 7). Tritium is produced, upon neutron bombardment from the combustion chamber, by dissociation of the lithium nucleus and extracted by separation. Tritium is then injected into electrodes with equal parts of deuterium to form a 50-50 DT mix. Preferably, unspent tritium is also recovered from the divertor region 301 by pumping exhaust gases through a tritium purification and separation device. The waste He gas is separated and exhausted, while fuel is reintroduced to the combustion chamber via electrodes. The tritium system is closed so that proper accounting and inspection is possible. Lithium is a good breeder material considered for many fusion device systems and is safer than liquid sodium.

### Site Plan for Plasma Compression System

### Power Station

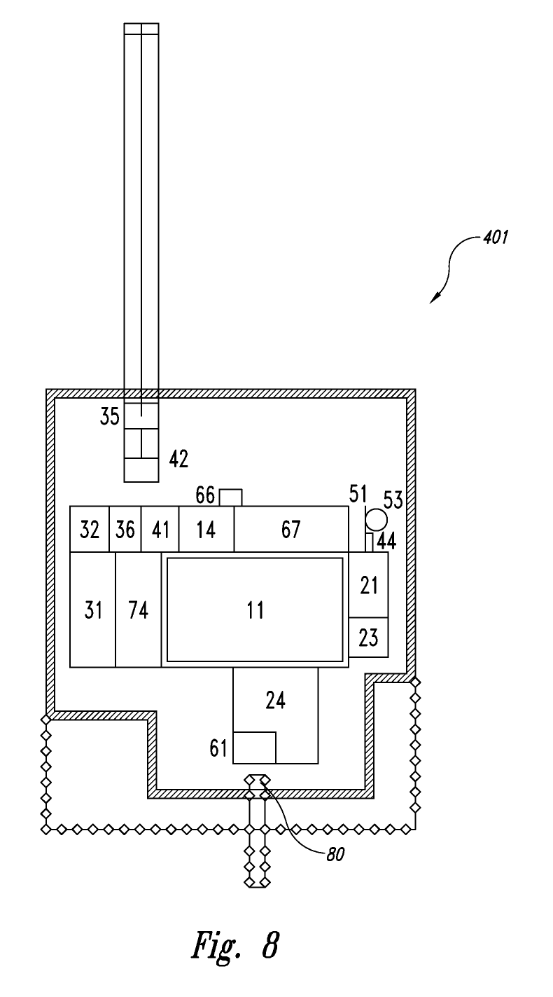

Particular aspects provide a site-layout for the disclosed plasma compression devices. FIG. 8 shows an exemplary site-layout 401 for a plasma compression device when used in combination with a blanket 7, divertor portion 201, and tritium breeding. Near the center of the power station, is the plasma compression device hall (engine hall) 98. To further increase safety, the device is surrounded by meter thick walls of concrete, and ceiling vanes provide a path for gas vented in a failure. The immediate surrounding rooms are those integral to the running of the power station. Directly next to the engine 98, is the turbine hall 67 where heat from the engine 98 will be directed. Next to the turbine hall 67 is the tritium, vacuum, fueling, and service building 14. To the right of the engine 98, is the hot cell room 21 and low level radwaste room 23. The location of this rooms allow for easy remote access when handling waste and other components of the engine. Directly to the left of the engine hall are the diagnostics and PF coil fast discharge resistors and capacitors 74. The control room 71 and site services room 61 is located at the entrance to the building 80. The remaining rooms to the left 31-36 are provided for power and power conversion for the station. There is a magnet power conversion room 32 as well as a magnet power supply switching network 31. There is a pulsed power high voltage substation area 35 allowing for power to come in and out of the building. A step-up transformer 42 is connected to the pulsed power voltage substation 35 as well. The building additionally comprises rooms for an emergency power supply 41 as well as an alternating current distribution room 36 for the whole building. The remaining power component, 3.3 kV switchgear structures 44, is located near the cryoplant storage tank 52 and cryoplant coldbox and PF coil fabrication room 51, to the right of the turbine hall 67. An additional storage room for gas 66, is located near the tritium, vacuum, fueling, and services room 14. As will be appreciated by one of ordinary skill in the art, alternate combinations and subcombinations of these elements may be used, and suitably configured in various spatial configurations to provide for operation of the disclosed plasma compression devices, and the embodiment of FIG. 8 is not intended to limit the scope of the site-plan aspect.

### Preferred Operation of Plasma Compression Device and Components Thereof

Overview. According to particular preferred aspects, and turning to FIGS. 1A and 1B, a plasma compression device 101 comprising a plasma combustion chamber 2, and blanket 7 and shield means for capturing neutrons (see FIG. 2) and breeding fuel using a circulating blanket fluid is provided, along with various components thereof (as variously described herein above), including, but not limited to: an annular parallel formation electrode system 201 (FIG. 3) suitable for generation of magnetized toroidal plasma; a moveable member (e.g., piston), operatively coupled to cam means, for positioning attached and/or integral magnetic field coils 5 and 6 in relation to the plasma 3 during plasma generation and compression, the piston and cam means providing for transfer of force/energy between the combustion chamber and desired devices (e.g., energy generator, motor, devices for empowering the cam, etc.) operably coupled to the cam means; and a divertor portion 301 (FIG. 5) for transporting hot particles out of the combustion chamber to the divertor target surfaces 13, 14, the divertor comprising a divertor plug with blanket section 10 to protect the divertor components and target surfaces from neutron bombardment, along with pump means (e.g., cryogenic pumps or turbo pumps) mounted outside the shield 99 for pumping exhaust gases out of the system via divertor chamber 8. Preferred operation of the plasma compression device 101 and particular components thereof is now described.

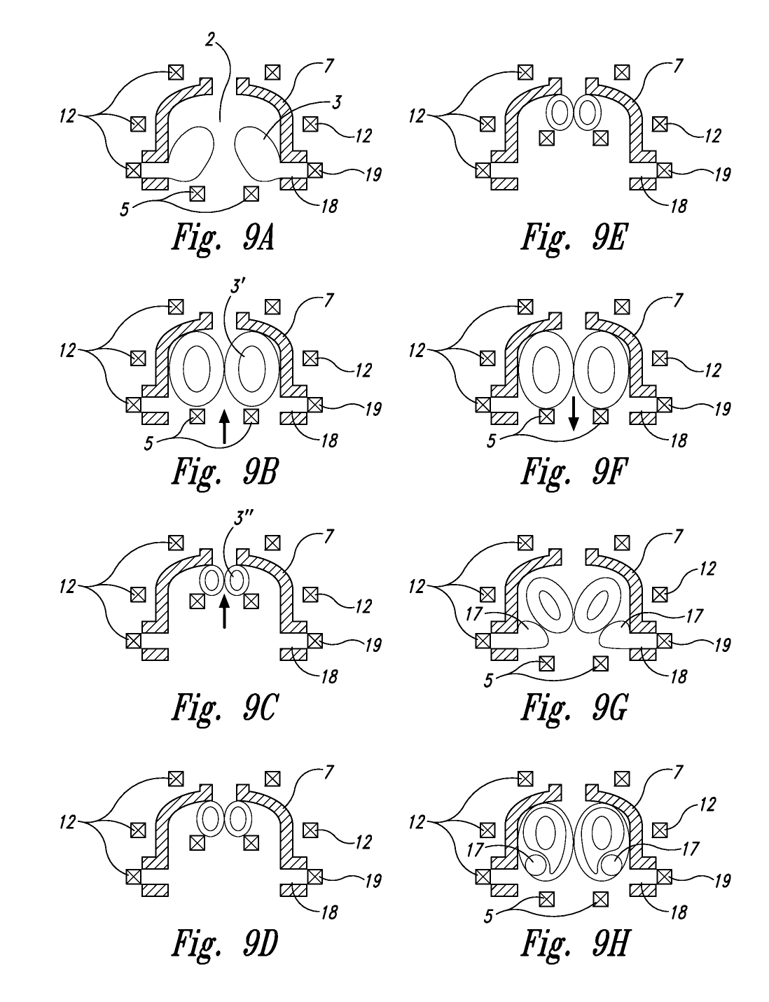

Turning now to FIG. 9, a schematic is shown of the compression cycle of the inventive plasma compression device. Initially the combustion chamber 2 is pumped down to a vacuum and current flows in field coils 12, 5 and 6 (see FIG. 2 for preferred coil positions), creating a vacuum field. With reference to FIG. 9A, injection of plasma into the combustion chamber is initiated when magnetized plasma 3 is generated between the formation electrodes at position 1 (as describer in more detail elsewhere herein) and is expelled inwardly into the magnetic well of the combustion chamber 2 as a plasma ring that carries both poloidal and toroidal current. Current build-up occurs at peak expansion so that electrode power loading is minimized. Operatively, the electrodes are pulsed several times to increase the current in the plasma 3 trapped in the magnetic well of the combustion chamber 2. Each successive inwardly expelled current-carrying plasma ring reconnects with the first thereby adding current to the, stabilized trapped plasma. After the pulsed build-up of current ends, a high current spheromak (relaxed spheromak) 3′ is formed (FIG. 9B). This state is characterized by ∇×B=λB (where λ is a single number determined by the geometry). Thus far, the plasma compression device is somewhat similar to an art-recognize coaxial magnetized Marshall Gun, except that the “gun” is displaced from the combustion chamber radially, not axially. Once the relaxed spheromak is formed and has become quiescent (as shown in FIG. 9B), the piston-coil assembly comprising magnetic field coils 5, 6 begins to move vertically to initiate the plasma compression (see FIGS. 9B and 9C). The current and size of the field coils 12, 5 and 6 are designed to provide equal degrees of radial and axial compression to the spheromak, which is feasible as long as compression ratios are in the range of 3, or about 3 or less. As confirmed by the calculations herein below, self-similar spheromak compression is provided where the helicity of the spheromak remains fixed and the magnetic energy increases during compression in such a way as to maintain a constant current profile throughout the plasma compression. According to particular preferred aspects, maintaining a constant current profile throughout the plasma compression insures that the compression phase will encounter no disruptions or large-scale instability, which would otherwise lead to severe plasma heat loss and damage of the combustion chamber walls. With reference to FIG. 9C, for a sufficiently compressed state, the plasma 3″ achieves ignition and alpha particle (positively charged particle, indistinguishable from a helium atom nucleus and consisting of two protons and two neutrons) heating then exceeds the losses from Bremsstrahlung radiation. Preferably, the compression is adjusted if necessary (e.g., piston field coils positionally adjusted, advanced or backed-off; and/or field coil strength adjusted) to maintain the temperature in a suitable burn range and without reaching a pressure limit (see exemplary backing-off in FIG. 9D). With reference to FIGS. 9E and 9F, once the fuel (preferably deuterium and tritium fuel) is expended, the piston-coil assembly backs off, and an instability is deliberately excited to cause a loss of core confinement and dispose of spent fuel (helium ash). The instability is excited by allowing the q-profile to span the q=½ mode rational surface, to cause the 2/4 island to grow, which causes a transient loss of core confinement and spent fuel is immediately transported to the divertor surface and pumped away, and new fuel and helicity is added by pulsed injection of plasma from the electrodes during a “reflux and refuel” stage. With reference to FIGS. 9G and 9H, during the reflux and refuel stage, new fuel 97 (magnetized plasma) combines with the spheromak in a magnetic relaxation process, similar to the initial spheromak formation, and the cycle begins again.

As will be appreciated by one of ordinary skill in the art, operative variations of the above preferred compression cycle employing a movable member (piston) with attached or integral coil(s) to compress a plasma in a magnetic well within a plasma combustion chamber are encompassed within the general scope of the above preferred mode of operation, provided the compression phase is balanced so as not to encounter disruptions or large-scale instability that would lead to severe plasma heat loss and/or damage of the combustion chamber walls, and, as discussed below, provided the compression time-scale remains much shorter than the magnetic field decay time and/or comparable to the energy confinement time.

According to alternate aspects, for example, the plasma can be compressed on a sinusoidal cycle with low duty cycle so as to limit the power obtained from fusion reactions and permit more frequent fueling of the plasma.

According to additional aspects, approaching (e.g., close to) peak compression, the compression ratio could be increased at a rate to allow for constant output power as the fuel inventory depletes. Alternatively, plasma compression is continued at a rate matching resistive dissipation to obtain constant q at the magnetic axis.

In yet further aspects the compression and/or reflux ramp up dwell times can be varied or adjusted to accommodate different fuels and different energy output requirements.

Additionally, the number and/or strength and/or relative positioning of the various field coils can be varied—again with the proviso that the compression phase is balanced so as not to encounter disruptions or large-scale instability. and, as discussed below, provided the compression time-scale remains much shorter than the magnetic field decay time and/or comparable to the energy confinement time.

In yet further alternate embodiments the architecture of the combustion chamber and/or of the magnetic well and/or of the number and/or configuration of the piston surface(s) (e.g., flat, concave, convex, etc.)—again with the proviso that the compression phase is balanced so as not to encounter disruptions or large-scale instability and, as discussed below, provided the compression time-scale remains much shorter than the magnetic field decay time and/or comparable to the energy confinement time.

Turning now to FIG. 10, a Pressure-Volume (P-V) diagram for the preferred plasma compression device is shown. In the instant plasma compression system, technically, the process is not completely adiabatic; that is, the plasma compression is not without addition or loss of heat, since even at the beginning of the compression cycle, there is a finite probability of fusion reactions occurring, which increases as the plasma is compressed, thereby increasing the pressure above what might be expected from compression alone. As described above, ignition is defined as the point at which the alpha particle heating exceeds the bremsstrahlung losses, which, unlike in a gasoline combustion, is reached gradually as the alpha heating grows during compression. Moreover, also in contrast to gasoline engine combustion, the dominant pressure is set not by the thermal gas (nkT), but by the magnetic fields generated by currents in the thermal plasma (B²/2μ₀) and is larger by the ratio of 1/β((β=nkT/B²/2μ₀)

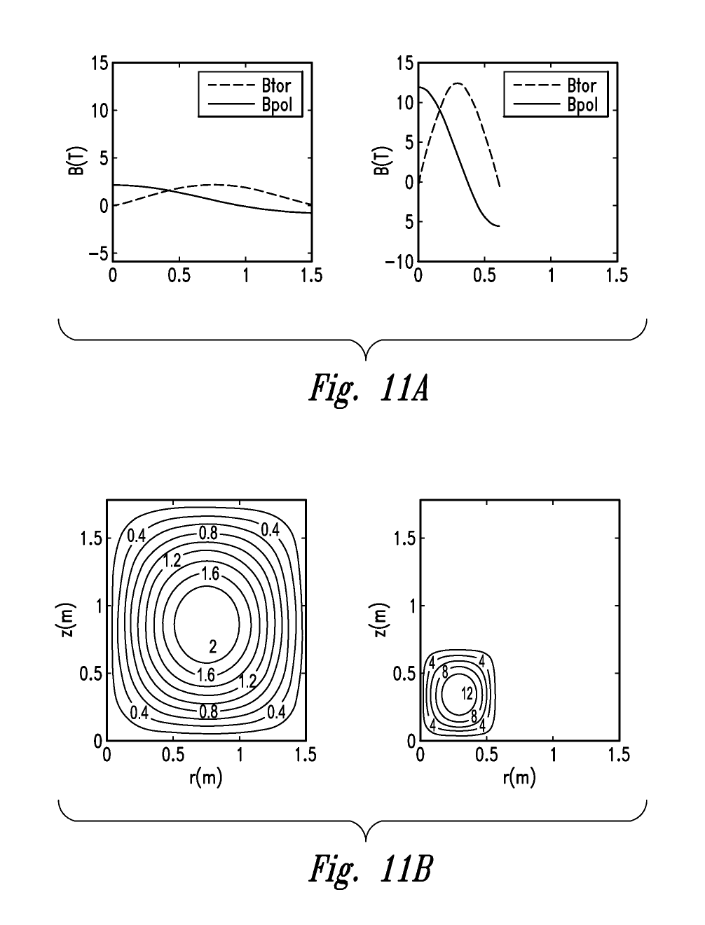

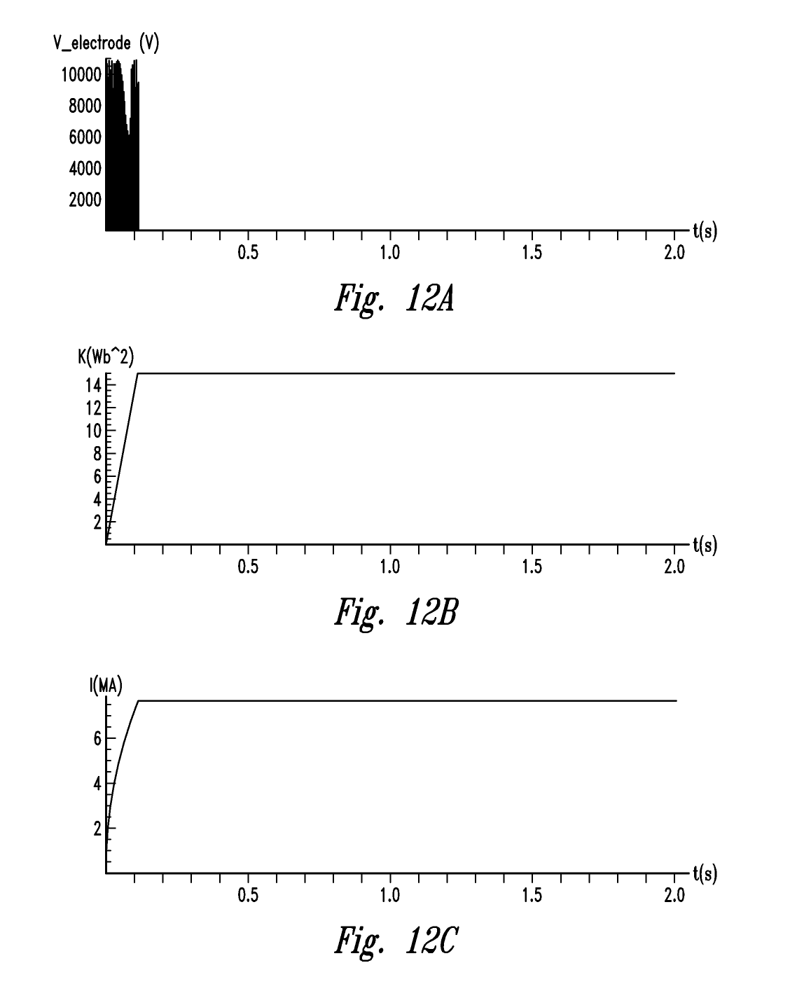

With reference to FIGS. 10, 11A and 11B, the preferred embodiment of the instant compression cycle is therefore described as follows. From A to B (FIG. 10), the plasma pressure, prior to piston-mediated compression, is increased by the pulsed injection of current-carrying plasma from the plasma formation electrodes, serving to incrementally build magnetic pressure to approx. 1 atm, temperature to approx. 1 keV, density to approx. 10²⁰ particles per m⁻³ and magnetic field strength to approx. 2 T (see FIG. 11A). From B to C (FIG. 10), the plasma is compressed on a period comparable to the energy confinement time (and a time-scale much shorter than the magnetic field decay time), which means that the alpha particles produced during this time will be trapped in the plasma and add to the plasma pressure, thereby causing the curve to depart from a perfect adiabat. Ultimately, with complete compression in the instant preferred system, a pressure of approx. 400 atmospheres, temperature of approx. 10 keV, density of approx. 3×10²¹ m⁻³ and magnetic field of approx. 12 T is reached (see FIG. 11B). Moreover, from B to C (FIG. 10), energy is lost from the plasma in the form of neutrons (which are captured by the surrounding blanket). Between C and D (FIG. 10), the plasma is maintained at peak pressure by slightly increasing the compression (reducing the volume) while the plasma decays resistively. After an approx. 1 minute burn period, the plasma is expanded along D to A (FIG. 10), where at A, the pressure is again incrementally increased by pulsed injection of current-carrying plasma from the plasma formation electrodes.

As will be appreciated by one of ordinary skill in the art, operative variations of the above preferred compression cycle are encompassed within the general scope of the above preferred mode of operation, provided the compression phase is balanced so as not to encounter disruptions or large-scale instability that would lead to severe plasma heat loss and/or damage of the combustion chamber walls. According to Alternate embodiments, for example, the plasma compression is performed on a time-scale short compared with the energy confinement time (A to B; FIG. 10), to shape the plasma at peak compression to increase the pressure limit (increase electron beta) (B to C; FIG. 10), expanding the plasma at high beta to produce a drive stroke (C to D; FIG. 10), then changing to a low beta configuration (D to A; FIG. 10).

FIGS. 11A and 11B show the internal magnetic field profiles (FIG. 11A) and toroidal flux surfaces (FIG. 11B), respectively, along an equatorial radius in the uncompressed (upper and lower left panels) and compressed states (upper and lower right panels). With compression, the plasma retains its shape, and the magnetic flux of the plasma is conserved to give an increase in the magnetic field strength from a peak of 2 T on axis to 12 T.

According to yet further aspects, using super-conducting coils, the peak magnetic field of 12 T can be exceeded, thereby allowing stronger magnetic field strengths, and smaller system sizes.

### The Plasma Compression Provides for Fusion Regimes

According to particular aspects, a novel device and method for magnetized plasma compression is provided as described in detail herein. According to additional aspects, the device and method provides for thermonuclear ignition regimes (fusion regimes) for provision of energy.

Accordingly, the degree of compression is parameterized by C=a₀/a, where a is the minor radius of the spheromak. Scalings of various fields with C follow from global conservation laws, and it is shown a posteriori that these hold, for example, for the instant preferred embodiment.

Conservation of toroidal flux leads to the scaling of magnetic field strength with compression:

B=B₀C².

Conservation of magnetic helicity K=∫dVA·B and B=∇×A are both consistent with the vector potential scaling as A=A₀C¹, and current density scaling as:

J=J₀C³.

The parameter λ appearing in the minimum energy condition ∇×B=λB scales as:

λ=λ₀C¹.

Taken together, these scalings mean that magnetic energy ∫dV μB²/2 increases as C¹ (the energy being provided by the force on the piston), while the ratio of energy to helicity increases as C¹. Moreover, these electromagnetic scalings collectively mean that a relaxed-state device contracts in a self-similar fashion, with no need for any relaxation events to flush surplus energy. Particle conservation leads to the scaling of density with compression:

n=n₀C³

and conservation of heat during adiabatic compression, pn^{-5/3}=const., leads to temperature that scales as:

T=T₀C²,

and from these we obtain the scaling of the plasma β:

β=8πp/B²=β₀C¹

With such large increases in fields, it is important to establish that resistive dissipation remains reasonably low, and auxiliary current drive is not required. Resistive dissipation of magnetic energy is:

$$\frac{d}{d t} {W}_{mag} = \int d V η {J}^{2} ,$$

where η is the usual Spitzer resistivity. Since η∝Tₑ⁻3/2, this dissipation scales as:

$$\int d V η {J}^{2} = \int \frac{d {V}_{0}}{{C}^{3}} \frac{{η}_{0}}{{C}_{0}^{3}} {( {J}_{0} {C}^{3} )}^{2} = \int d {V}_{0} {η}_{0} {J}_{0}^{2} . ,$$

showing that field energy dissipation remains constant throughout compression. In fact, since W_{mag}; increases as C¹, the relative amount of magnetic energy loss actually decreases with compression. Likewise, resistive helicity dissipation scales as:

∫dVA·B=C⁻¹∫dV₀η₀J₀·B₀.,

showing that helicity dissipation also decreases with compression.

Based on the above, and according to particular aspects, resistive dissipation does not cause any significant degradation of the spheromak.

According to further aspects, the parameters required of the plasma compression device are provided. Preferably, a plasma is selected such that it can be brought to ignition with a compression ratio of no more than C˜3. Requiring a compressed temperature of around 10 keV for fusion gives an initial temperature requirement of T₀˜1 keV (which is attained in prior art spheromak plasmas). Since copper field coils have a maximum field around B˜15 T or so, then the compressed plasma field preferably remains less than about 12 T in order to remain confined by the coil, so B₀<2 T is preferred in the initial field, given the above scaling.

Preferably, β<Λ or so in order to maintain dominantly magnetic confinement, and provide insulation against pressure-driven instabilities. This in turn requires β₀<0.06, or using the limits of B₀ and T₀ above:

n₀<0.06B₀²/8πT₀˜1.5×10²⁰m⁻³,

which is readily satisfied.

The empirical Greenwald density limit requires that n/J<10²⁰/m M a remain throughout the compression in order to avoid high radiation and collapse of the discharge. With n and J both scaling as C³, the Greenwald ratio remains constant despite the large increase in both quantities, so a spheromak that satisfies this limit initially continues to do so throughout compression.

Provided energy confinement time scaling as τ_{E}˜a²/χ, and thermal conductivity χ to scale as χ=χ₀C⁰, and the compression time to scale as τ_{C}˜a/Vₚ (where is the velocity of the piston), the requirement that τ_{E}>τ_{C}, leads to the requirement:

Vₚa₀≧χ₀C^{a+1}.

Empirically, χ₀≅5 m²/s for an uncompressed spheromak (as in the instant case). Table 1 shows a number of energy transport models, and their scaling with C. The initial confinement sets the dominant constraint on Vₚ for Ohmic confinement scaling, which is a conservative estimate for the confinement (and interestingly scales as C⁻² and is thus independent of compression), and hence provides an upper bound to the piston velocity:

Vₚa₀≧5m²/s.

For a spheromak with a₀˜0.5, this gives Vₚ>10 m/s, well within the range of prior art piston propulsion devices (e.g., cams and followers). This Vₚ is well below the sound speed (˜3×10⁵ m/s and Alfven speed (˜2×10⁶ m/s, as required for adiabatic compression.

TABLE 1
Scaling of confinement with compression
for dominant confinement models.
C Scaling of Various Thermal Transport Models

| Model | λ_{E}~α²/τ_{E} | _{χE}(C) |
|---|---|---|
| Braginskii | Tᵢ/mᵢΩᵢ²τᵢ | _{χ0}C⁻² |
| Bohm | T/eB | _{χ0}C⁰ |
| GyroBohm | Tρᵢ/eBα | _{χ0}C⁰ |
| Ohmic | α/nR²qₑ | _{χ0}C⁻² |
| Goldston | α^{2.37}P^{0.5}/IR^{1.75}κ^{0.5} | _{χ0}C^{-1.6} |

Turning now to FIGS. 12A through 12 F, the time variation of various macroscopic quantities for the exemplary preferred embodiment is shown during the compression phase of the burn cycle (B to C in FIG. 10). In sequence: FIG. 21A shows the voltage applied to the electrodes as a series of pulses to produce a series of injections bringing about a step-wise increase of magnetic helicity with time; FIG. 12B shows helicity of the spheromak; FIG. 12C shows the plasma current in the spheromak as it ramps up to 7 mega Amperes; FIG. 12D shows the core plasma temperature measured in keV; FIG. 12E shows the core plasma density measured in particles per m⁻³; and FIG. 12F shows the triple product of density, temperature and confinement time showing the approach to the Lawson condition (see horizontal dashed line in FIG. 12 F) for the Lawson condition, sometimes referred to as ‘ignition’.

### Physics of Electrode-Mediated Plasma Formation Phase

As described in detail herein, during the plasma formation phase, energy is input to the system by used of parallel magnetized electrodes. Magnetic field generation is often described with the use of magnetic helicity, which is a measure of the linkage of the magnetic flux, is additive, and is conserved globally in instances where magnetic energy is not (e.g., reconnection). The helicity injection rate of a spheromak formed with coaxial electrodes is expressed in terms of the voltage and the flux linking two coaxial electrodes: dK/dt=2Vₑψₑ, and global helicity evolution is then:

$$K ( t ) = exp ( {\int }_{0}^{t} \frac{- d t}{{τ}_{κ}} ) {\int }_{0}^{t} 2 {V}_{e} ( {t}^{′} ) {ψ}_{e} ( {t}^{′} ) exp ( {\int }_{0}^{{t}^{′}} \frac{d {t}^{″}}{{τ}_{κ}} ) d {t}^{′} . \qquad ( 1 )$$

For time-scales short compared with the helicity dissipation time, the integral can be simplified to:

K(t)=∫₀^{t}2V_{c}(t)ψ_{c}(t)dt. (2)

An effective helicity injection rate is thereby expressed in terms of inductive plasma processes as follows:

$$\begin{matrix}{K}_{eff} ( t ) = {\int }_{0}^{t} 2 \dot{L} ( t ) I {ψ}_{e} ( t ) d t + {\int }_{0}^{t} 2 \dot{I} ( t ) L {ψ}_{c} ( t ) d t , or & ( 3 ) \\ \frac{d {K}_{eff}}{d t} = 2 \dot{L} I {ψ}_{e} + 2 \dot{I} L {ψ}_{e} . & ( 4 )\end{matrix}$$

As appreciated in the relevant art, some inductive processes exhibit geometric changes like the plasma arcades of a Jacob's ladder: an area change results in a large \dot{L} term and so the first term in the right side (of equation (4)) is dominant. Inductive voltage changes result from V=\dot{L}I, the maximum L expected would be L=(μ₀/2 π)lₛₕₑₑₜ log(r₂/r₁) where r₂ and r₁ are the outer and inner plasma radii respectively, and lₛₕₑₑₜ is the height of the chamber, giving L=10 μH and a voltage spike of approximately 10 kV. According to particular aspects, therefore, several pulses incrementally build the magnetic energy (as reflected by the helicity and/or plasma current) of the spheromak as shown in FIGS. 12B and 12C (The plasma then decays with a dissipation time set by resistivity (independent of compression). After plasma formation, closed-flux surfaces form and the spheromak is compressed adiabatically on a time-scale short compared with the energy confinement time. Just prior to compression, the spheromak plasma has a temperature of approx. 1 keV and density of approx. 10²⁰ m⁻³, which rapidly increases to approx. 10 keV and approx. 10²² m⁻³ respectively. These parameters are sufficient, in combination with an energy confinement time, for fusion reactions to occur, as shown schematically in FIG. 12F (where the horizontal dashed line represents the Lawson condition for ignition of nTτ_{E}=10²¹ m⁻³ keV-seconds, which is easily exceeded for a conservative confinement model (see Table 1) (shown in FIG. 12F is the curve for Ohmic confinement scaling).

According to particular aspects, therefore, using the disclosed method and apparatus, magnetized plasma is compressible to conditions requisite for initiation of fusion reactions to provide, for example, a neutron source.

### Power Production

According to yet additional aspects, the disclosed magnetized plasma compression device has substantial utility as a fusion reactor in which fluxes of neutrons and hot particles released during compression are captured to produce useful energy (e.g., electricity, heat, fuel breeding, etc).

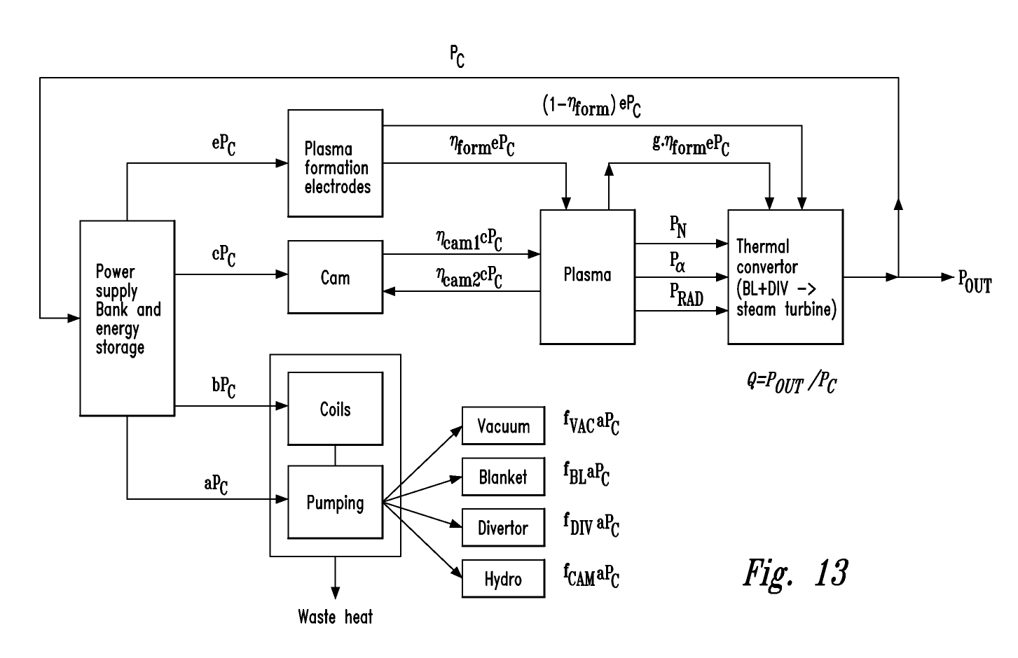

As appreciated in the art, determining the power balance of a system is a useful way of calculating the useful power obtainable from the system. Turning now to FIG. 13, an energy flow diagram for the disclosed plasma compression device is shown. On the left is the input energy which is channeled into four branches: (i) to charge the capacitor banks for use in the formation and refueling of the plasma with an efficiency, e, set by the transmission coupling to the plasma (eP_{c}); (ii) to initially energize the cam (cP_{C}); (iii) to the coils which are maintained at constant current (bP_{C}); and, (iv) to the various pumping systems (aP_{C}). It is assumed, as customary in the art, that no heat is usefully recovered from the pumping and coil systems. The cam 9 energy is coupled to the plasma 3 by the follower 11 and piston 4, with losses due to friction in the follower 11 and piston (nᵢₙcP_{C}), and due to particle heat losses from the plasma 3 in the compression and expansion. During the burn phase, the plasma expels heat in the form of neutrons (Pₙ) and hot particles (Pₜₕ) and radiation (P_{rad}) which are converted in the blanket and a fraction is converted to useful output power by use, for example, of a turbine, with a typical efficiency of approx. 0.4.

### Power Sinks:

Power to the electrodes to maintain plasma in quasi-steady-state, eP_{C}. Typical art-recognized conversion efficiencies for spheromak formation are of the order of 10%, so for the provision of a magnetic energy of 20 MJ in the initial plasma state prior to compression, the bank size is of the order of 200 MJ. Considering a reflux cycle of approx. 1 minute, in which 10% of the magnetic energy needs to be replaced, leads to a steady-state power consumption of approx. 20 MJ every minute, which gives eP_{C}=300 kW. Some of the power is recovered as heat in the blanket, but is ignored providing a conservative upper bound.

Power consumed in the compression, cP_{C}. Three bearings are used in the instant preferred embodiment, which all bear a similar load of 6MN. Computed over the cycle, the power absorbed in the bearings is less than 100 kW. During a compression cycle, up to 10% of the magnetic energy is lost by resistive dissipation. This loss represents also a pressure loss which is not recovered during the expansion phase of the plasma. Considering 10% of 40MJ of the stored energy being lost to resistive dissipation per cycle, this converts to a power loss of approx. 70 kW.

Power consumption in the coils, bP_{C}. To support the equilibrium stably, each external coil will be required to carry up to 3MA of current. For the 7MA equilibrium shown in FIG. 4, these are calculated to be 3, 0.8, 0.17, 0.64, 0.79, 0.045, 0.093 and 1.9 MA for coils 1 through 8, respectively. Given the resistivity of copper, the cross-sectional area of each turn and the length of each turn and the number of turns per coil, the power consumed in the provision of the magnetic field is determined from P=I²R, giving bP_{C}=700 kW for the preferred embodiment.

Pumping power needed for the Pb—Li blanket fluid, aP_{C}. Typically this power is large for tokamaks in which the liquid lead is forced to flow perpendicular to the magnetic field (a≦0.1). However, with the instant preferred design, the flow is parallel everywhere, and so this power consumption is small compared with power to the coils or electrodes. Similarly, other pumping power is ignored, being small in comparison to consumption by the coils.

### Power Output:

A natural limit to the obtainable power from the disclosed system is governed by the surface area of the first wall, which for a compression of 2.5 in our preferred embodiment is 4 m², and a maximum art-recognized neutron wall loading of 5MW/m², results in a neutron power of 20MW. Alpha power (alpha particle-derivable power) is channeled to the divertor surface, which absorbs another 5MW. According to particular aspects, about ⅓ of the Bremsstrahlung power is absorbed in the first wall, giving another 2MW of power. In total, the power that can be absorbed is governed by the geometry of the configuration, resulting in about 27MW of harnessable power per cylinder.

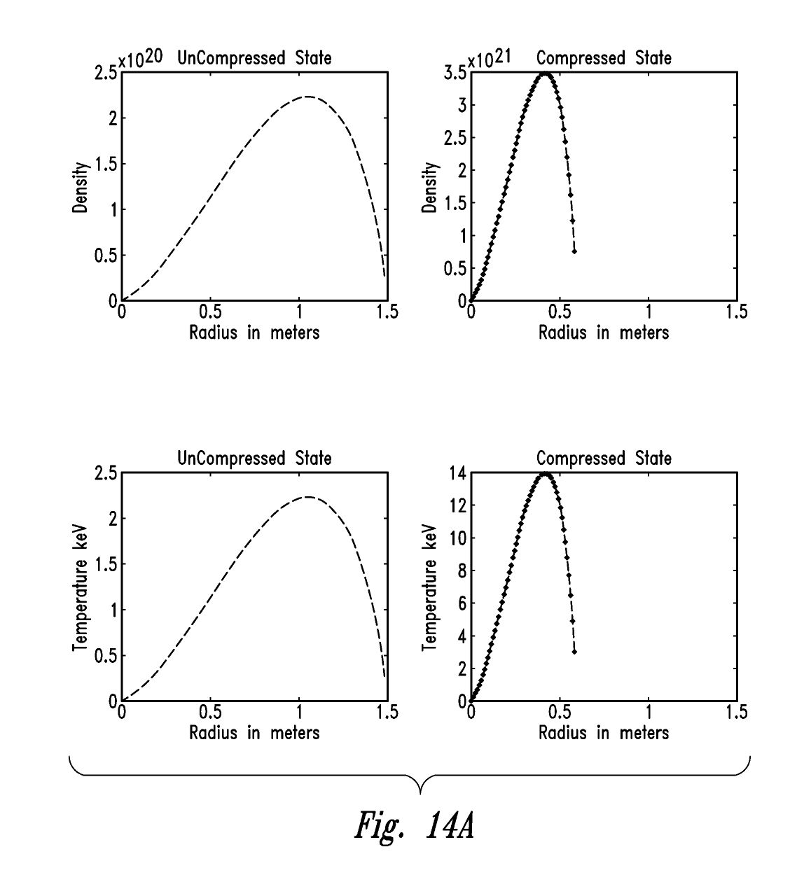

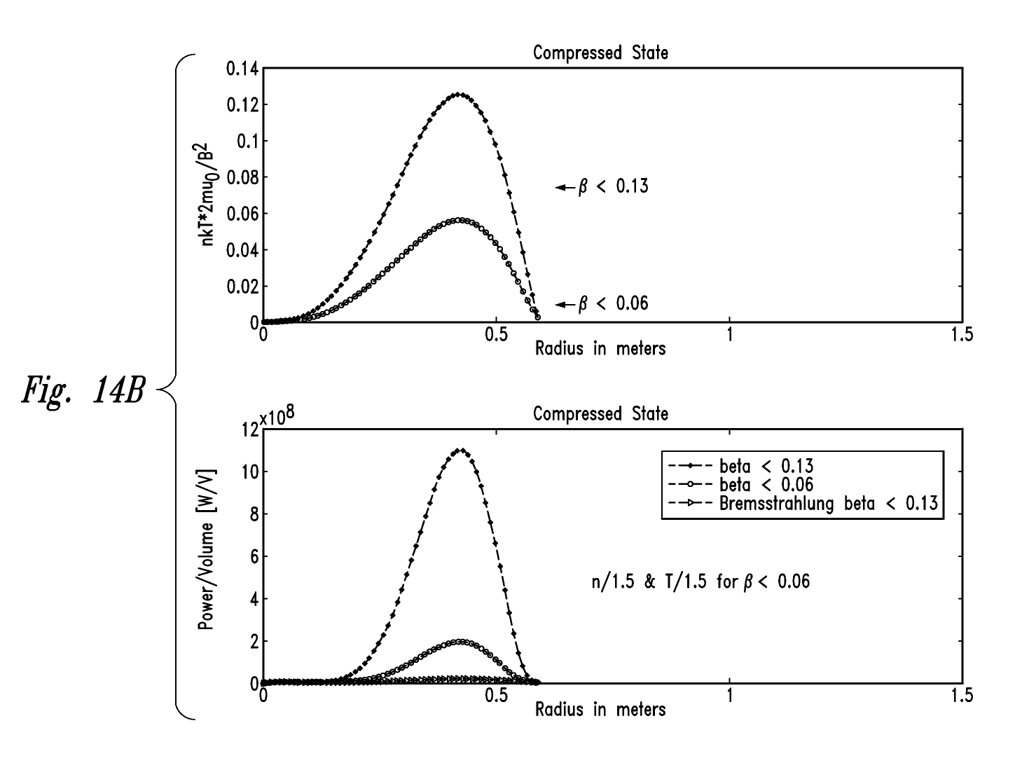

Power from the plasma in terms of neutrons (Pₙ), alphas (Pₜₕ) and radiation (P_{rad}). FIG. 14B (shows the total fusion power from the plasma compression system computed as a function of radius. The total power is computed by use of the equation:

P_{fusion}=η_{DT}² [symbol] συ [symbol] E_{DTneutrons}.

In calculating the total power, some assumptions are made based on previous experiments. It is understood in the art that density profiles and temperature profiles are functions of flux for a spheromak, so, in an uncompressed state, the density will follow a profile described by the equation:

$${n}_{0} ( r ) = {{10}^{20} [ 1 - {( \frac{2 {r}^{2}}{{r}_{0}^{2}} - 1 )}^{2} ]}^{k} ,$$

and a compressed state is described by:

$${n}_{f} ( r ) = {C}^{3} {{10}^{20} [ 1 - {( \frac{2 {r}^{2}}{{r}_{0}^{2}} - 1 )}^{2} ]}^{k} ,$$

with C being the convergence factor. Similarly, uncompressed temperature profiles take on the form:

$${T}_{0} ( r ) = {1.2 [ 1 - {( \frac{2 {r}^{2}}{{r}_{0}^{2}} - 1 )}^{2} ]}^{k} ,$$

and compressed temperature profiles is described by:

$${T}_{f} ( r ) = {C}^{2} {{10}^{20} [ 1 - {( \frac{2 {r}^{2}}{{r}_{0}^{2}} - 1 )}^{2} ]}^{k}$$

for temperatures in keV.

By calibrating to existing data for spheromaks, k=0.75 matches well.

Collision cross sections as a function of temperature were obtained from the NRL Plasma Formulary.

[symbol]

συ [symbol] =3.6810⁻¹²T^{-2/3}exp(−19.94T^{-1/3})10⁻⁶[m³/sec].

Using the above equations, the power per unit volume is then:

$$\frac{1}{4} {( {n}_{f} ( r ) )}^{2} 〈 σ v 〉 {E}_{{DT}_{n}} 1.6 {.10}^{- 19} .$$

Volumetrically integrating, the total power in the system is:

$${P}_{f} = 2 π \int \int \frac{1}{4} {( {n}_{f} ( r ) )}^{2} 〈 σ v 〉 {E}_{{DT}_{n}} 1.6 {.10}^{- 19} sin ( \frac{π}{h / C} z ) d r d z .$$

For a system with a k=0.75 and a convergence of 3, calculated total neutron power for a β<0.1 is 121.1MW and for a β<0.2 is 677MW of power. With a convergence of 2.5 and β<0.1, the total neutron power is 22.3 MW and for a β<0.2 the power is 145.1 MW. With a convergence of 2.5 and β<0.05, the total power is 3MW and for a convergence of 3 and β<0.05 the power is 77.5 MW.

The power from Bremsstrahlung radiation is similarly calculated. A DT mixture has a Bremsstrahlung power of:

$${P}_{b} ( DT ) ≃ 2.14 {.10}^{- 30} {n}_{DT}^{2} {T}_{c}^{1 / 2} [ \frac{W}{{cm}^{2}} ] …$$

With the density of the deuterium and tritium being the same in a 50-50 mixture, the equation further simplifies to:

$${P}_{b} ( DT ) ≃ 2.14 {.10}^{- 30} {n}_{D}^{2} {n}_{T} {T}_{e}^{1 / 2} [ \frac{W}{{cm}^{3}} ] .$$

This density is the same compressed density used in the thermonuclear power calculations above.

For the instant preferred configuration, the operating points of β=0.1 and C=2.5 are optimal.

The output power is convertable to electricity with a thermal conversion efficiency of 0.4, which means that 10.8MW is available as output power. Subtracting out the power required for sustaining the configuration in steady state, the useable electrical output from the facility is, according to particular aspects, about 8MW.

According to alternate embodiments, shaping the plasma during the compression phase, increases beta significantly above 10%, thereby giving larger output powers for similar plasma volumes.

### PUBLICATIONS CITED IN THE TEXT, AND INCORPORATED BY REFERENCE FOR THERE REFERENCED AND RELEVANT TEACHINGS

R. Paul Drake et al., “Submegajoule Liner Implosion of a Closed Field Line Configuration,” Plasma Engineering 33, 310 (1996).
R. F. Post et al, “Stable Confinement of a High Temperature Plasma” Phys. Rev. Lett. 4, 166 (1960).
D. R. Wells et al, “Adiabatic Compression of Plasma Vortex Structures” Phys. Rev. Lett. 33, 1203 (1974).
J. B. Taylor, “Relaxation of Toroidal Plasma and Generation of Reverse Magnetic Fields”, Phys. Rev. Lett. 33 (1974).
J. Wesson, “Tokamaks, Second Edition” Oxford University Press (1997).

### Additional Embodiments

Provided is an apparatus for refluxing the magnetic fields in a quasi-steady state spheromak, comprising magnetized parallel annular electrodes for forming a toroidal plasma said means having a cylindrically symmetric solenoid for generating vacuum magnetic fields; magnetic coils for maintaining the equilibrium and stability of the configuration; means for producing pulsed injection of magnetic helicity to form and reflux the spheromak.

Additionally provided is an apparatus for maintaining the total magnetic energy or helicity of a spheromak in a quasi-steady state, wherein said means for producing magnetic energy or helicity is a DC electrical power supply electrically connected to said electrodes through a switch.

Further provided is an apparatus for apparatus for maintaining a quasi-steady-state toroidal plasma as recited in claim 1 wherein said means for maintaining equilibrium is a set of externally mounted coils poloidal field coils and a conducting layer mounted inside a blanket module having sufficient conductivity to establish eddy currents.

Additionally provided is an apparatus for moving a piston containing a coil and blanket module that causes an adiabatic compression of the spheromak plasma, maintaining said quasi-steady-state plasma in equilibrium at each successive phase of the compression and isolating from the walls by means of magnetic fields.

Further provide is an apparatus for producing quasi-steady state spheromaks by pulsed injection of magnetic energy or helicity comprising at least one layer of annular parallel electrodes and solenoid, electrical input for said electrodes, gas input means providing particle species for a discharge between said electrodes and an open annular breech for passage of resulting toroidal plasmas; means for maintaining the equilibrium for said toroidal plasma after repeatedly pulsed formation; and for producing electrical isolation of the plasma from the electrodes subsequent to refluxing and formation.

Additionally provided is an apparatus for producing quasi-steady-state toroidal plasmas as recited in claim 5 further comprising a coating on the electrode surfaces of sufficient refractory properties to protect said electrodes from damage by heat loading.

Further provided is an apparatus for capturing the particle heat flux escaping from the plasma protected from neutron bombardment by a shield, channeling the particle flux to a surface or surfaces where such heat can be converted to useful work.

Additionally provide is an apparatus for converting the incident neutron flux to thermal energy to be captured in a steam cycle, having an annular and modular construction for quick disassembly and easy maintenance.

Provided are methods for producing a quasi-steady-state spheromak using annular parallel magnetized electrodes for generating a poloidal magnetic field, electrical input means for said electrodes providing particle species for a discharge between said electrodes, and an open annular breech for the passage of a resulting compact toroidal plasma, the method comprising: flowing a particle species between said electrodes of sufficient quantity for creating a plasma upon application of predetermined repeatedly pulsed discharge currents; and forming a toroidal plasma by discharging an electrical energy storage means across said electrodes.

Additionally provided are methods for compressing a quasi-steady-state spheromak to ignition, comprising use of a mechanically actuated moveable member or piston comprising a means for capturing neutrons and protecting the coils contained in the piston, wherein the method comprises: energizing a cam, using energy from an electrical source, to set a follower and piston in motion with velocity sufficient for compression of a spheromak plasma; magnetically isolating the spheromak plasma from the piston surface by use of coils mounted internally to the piston head; increasing current to the piston coil during compression to provide for continuous isolation of the plasma from the piston surface during compression; wherein the cam is configured to provide for a sufficient compression and period to provide for plasma ignition and burning, and wherein the piston can be optionally backed-off or positionally adjusted.

Further provided are methods for producing a loss of core confinement from a spheromak, comprising: cooling of outer surfaces of a plasma by expanding the plasma to alter the current profile, wherein the q=½ mode rational surface enters the plasma; applying a finite error field by use of an externally mounted coil providing for exciting a 2/4 island mode in the plasma within a combustion chamber; and pumping of helium ash from the combustion chamber.

Further aspects provide a method for maintaining current profiles during the compression phase comprising heating with at least on particle beam directed so as to intersect said toroidal plasma.

Also provide is a system for the production of electricity comprising a power core having at least one plasma compression devices entailing all subsystems (electrodes, combustion chamber, blanket, piston, follower, cam, divertor, etc) to provide power in the 10 to 100MW range (e.g., for terrestrial distributed power purposes).

Provided is an application for the production of power for propulsion of large ocean-going vessels entailing all of the subsystems mentioned in claim 9 and others that may be necessary as listed in this application.

Additionally provide are application for the production of power for propulsion of medium-sized ocean vessels.

From the foregoing description, it will thus be evident that the present invention provides a design for plasma compression devices than that function as electric power transformers. As various changes can be made in the above embodiments and operating methods without departing from the spirit or scope of the following claims, it is intended that all matter contained in the above description or shown in the accompanying drawings should be interpreted as illustrative and not in a limiting sense.

Variations or modifications to the design and construction of this invention, within the scope of the appended claims, may occur to those skilled in the art upon reviewing the disclosure herein (especially to those using computer aided design systems). Such variations or modifications, if within the spirit of this invention, are intended to be encompassed within the scope of any claims to patent protection issuing upon this invention.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”). the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

1. A device for compression of a compact plasma, comprising:
a variable-volume plasma combustion chamber defined by a blanket wall and a movable compression member surface;
plasma formation and injecting means in communication with the combustion chamber;
a plurality of magnetic field coils, positioned outside the blanket wall and suitably configured to provide for a magnetic well within the combustion chamber;
a moveable compression member having at least one compression member magnetic field coil, the compression member and field coil moveable to vary the volume within the compression chamber; and
compression member positioning means suitable, in operation with the compression member and field coil, to provide for cycled positioning of the compression member to provide for cycled compression and decompression of plasma within the compression chamber.

2. The device of claim 1, wherein the plasma formation and injecting means comprises a pair of spaced annular parallel formation electrodes, suitably configured for generating and injecting magnetized compact toroidal plasma into the combustion chamber.

3. The device of claim 1, wherein the magnetic well is suitable for magnetically isolating plasma from the blanket wall of the combustion chamber, and wherein the at least one compression member magnetic field coil is suitably configured to provide for magnetic isolation of the plasma from the compression member surface.

4. The device of claim 1, wherein the moveable-member comprises at least one piston, each having at least one attached or integral magnetic field coil.

5. The device of claim 4, comprising a cam and a cam follower, the cam follower in operative communication between the cam and the piston to provide for cycled positioning of the piston within the combustion chamber.

6. The device of claim 1, wherein the combustion chamber comprises a divertor opening, the device further comprising a divertor portion with a divertor chamber in flow communication with the combustion chamber via the divertor opening.

7. The device of claim 6, wherein the diverting chamber is defined by at least one divertor blanket wall and at least one divertor target surface suitably configured to receive hot particles from the combustion chamber, and wherein the divertor comprises a plurality of divertor magnetic field coils, and at least one exhaust gas port.

8. The device of claim 7, wherein the divetor comprises a divertor shielding plug having a blanket wall, the diverter shielding plug and blanket wall suitably configured to shield the internal diverter chamber surfaces from particle bombardment from the combustion chamber.

9. The device of claim 1, wherein the plasma comprises a quasi-steady state spheromak plasma having approximately equal magnitudes of toroidal and poloidal magnetic field.

10. The device of claim 1, wherein the blanket wall of the combustion chamber comprises a combustion chamber-proximal shield layer and a blanket layer comprising channels suitably configured to provide for conveyance of a particle absorbing blanket fluid to provide for capturing of plasma-derived particles and/or heat flux emitted from the combustion chamber.

11. The device of claim 1, wherein the moveable compression member comprises means for capturing neutrons and protecting the compression member coil(s) therefrom.

12. The device of claim 11, comprising blanket means.

13. A device for compression of a compact toroidal plasma (spheromak) for fusion-mediated neutron generation, comprising:
a variable-volume plasma combustion chamber defined by a blanket wall and a movable compression member surface, the combustion chamber comprising a divertor opening, the combustion chamber blanket wall comprising a combustion chamber-proximal shield layer and a blanket layer comprising at least one channel suitably configured to provide for conveyance of a neutron absorbing blanket fluid to provide for capturing of plasma-derived neutron flux emitted from the combustion chamber;
a divertor portion having a divertor chamber in flow communication with the combustion chamber via the divertor opening;
spheromak plasma formation and injecting means in communication with the combustion chamber, the formation and injecting means suitable for generating and injecting a quasi-steady state spheromak plasma into the combustion chamber;
a plurality of magnetic field coils, positioned outside the blanket wall and suitably configured to provide for a magnetic well within the combustion chamber, the magnetic well suitable for magnetically isolating the spheromak plasma from the blanket wall of the combustion chamber;
a moveable compression member having at least one compression member magnetic field coil, the compression member and field coil(s) moveable to vary the volume within the compression chamber, the compression member magnetic field coil suitably configured to provide for magnetic isolation of the spheromak plasma from the compression member surface; and
compression member positioning means suitable, in operation with the compression member and compression member field coil, to provide for cycled positioning of the compression member to provide for cycled compression and decompression of plasma within the compression chamber.

14. The device of claim 13, wherein the plasma formation and injecting means comprises a pair of spaced annular parallel formation electrodes, suitably configured for generating and injecting magnetized compact toroidal plasma into the combustion chamber.

15. The device of claim 13, wherein the moveable-member comprises at least one piston, each having at least one attached or integral magnetic field coil.

16. The device of claim 15, comprising a cam and a cam follower, the cam follower in operative communication between the cam and the piston to provide for cycled positioning of the piston within the combustion chamber.

17. The device of claim 13, wherein the diverting chamber is defined by at least one divertor blanket wall and at least one divertor target surface suitably configured to receive hot particles from the combustion chamber, and wherein the divertor comprises a plurality of divertor magnetic field coils, and at least one exhaust gas port.

18. The device of claim 17, wherein the divetor comprises a divertor shielding plug having a blanket wall, the diverter shielding plug and blanket wall suitably configured to shield the internal diverter chamber surfaces from particle bombardment from the combustion chamber.

19. The device of claim 13, wherein the spheromak plasma comprises a quasi-steady state spheromak plasma having approximately equal magnitudes of toroidal and poloidal magnetic field.

20. The device of claim 13, comprising blanket means for converting the incident neutron flux to thermal energy to be captured in a steam cycle.

21. The device of claim 13, wherein the moveable compression member comprises means for capturing neutrons and protecting the compression member coil(s) therefrom.

22. The device of claim 13, further comprising a particle beam configured to intersect said toroidal plasma to provide for maintaining current profiles during the compression phase.

23. A spheromak-compression fusion reactor for fusion-mediated neutron generation, comprising:
a variable-volume spheromak plasma combustion chamber defined by a blanket wall and a movable compression member surface, the combustion chamber comprising a divertor opening, the combustion chamber blanket wall comprising a combustion chamber-proximal shield layer and a blanket layer comprising at least one channel suitably configured to provide for conveyance of a neutron absorbing blanket fluid to provide for capturing of plasma-derived neutron flux emitted from the combustion chamber;
a divertor portion having a divertor chamber in flow communication with the combustion chamber via the divertor opening, the diverting chamber defined by at least one divertor blanket wall and at least one divertor target surface suitably configured to receive hot particles from the combustion chamber, and wherein the divertor comprises a plurality of divertor magnetic field coils, and at least one exhaust gas port;
spheromak plasma formation and injecting means in communication with the combustion chamber and comprising a pair of spaced annular parallel formation electrodes, suitably configured for generating and injecting a quasi-steady state magnetized compact toroidal plasma into the combustion chamber;
a plurality of magnetic field coils, positioned outside the blanket wall and suitably configured to provide for a magnetic well within the combustion chamber, the magnetic well suitable for magnetically isolating the spheromak plasma from the blanket wall of the combustion chamber;
a moveable compression member having at least one compression member magnetic field coil, the compression member and field coil(s) moveable to vary the volume within the compression chamber, the compression member magnetic field coil suitably configured to provide for magnetic isolation of the spheromak plasma from the compression member surface; and
compression member positioning means suitable, in operation with the compression member and compression member field coil, to provide for cycled positioning of the compression member to provide for cycled compression and decompression of plasma within the compression chamber.

24. The device of claim 23, wherein the moveable-member comprises at least one piston, each having at least one attached or integral magnetic field coil.

25. The device of claim 24, comprising a cam and a cam follower, the cam follower in operative communication between the cam and the piston to provide for cycled positioning of the piston within the combustion chamber.

26. The device of claim 23, wherein the divetor comprises a divertor shielding plug having a blanket wall, the diverter shielding plug and blanket wall suitably configured to shield the internal diverter chamber surfaces from particle bombardment from the combustion chamber.

27. The device of claim 23, wherein the spheromak plasma comprises a quasi-steady state spheromak plasma having approximately equal magnitudes of toroidal and poloidal magnetic field.

28. The device of claim 23, comprising means for converting the incident neutron flux to thermal energy to be captured in a steam cycle.

29. The device of claim 23, wherein the moveable compression member comprises means for capturing neutrons and protecting the compression member coil(s) therefrom.

30. The device of claim 23, further comprising a particle beam configured to intersect said toroidal plasma to provide for maintaining current profiles during the compression phase.

31. The device of claim 23 configured to provide power for terrestrial distributed power applications, preferably in the 10 to 100MW range.

32. The device of claim 23 configured to provide propulsion of terrestrial and ocean-going vehicles.

33. An electrode apparatus for generating and releasing a spheromak, comprising:
a pair of spaced annular parallel electrodes defining an annular inter-electrode gap therebetween and radially-inward and radially-outward gap openings, the radially inward gap opening providing an open annular breech for release of toroidal plasma formable within the annular inter-electrode gap;
a solenoid member and vacuum means suitably configured for generating a vacuum magnetic field in the annular inter-electrode gap, the solenoid member positioned to seal the radially outward gap opening;
a gas inlet and valve means for introducing gas into the annular inter-electrode gap;
capacitor or DC electrical power supply means in electrical communication with the annular parallel electrodes and configured to be dischargable thereto to provide for breakdown of a gas in the annular gap to form a magnetized toroidal plasma (spheromak); and
one or more magnetic field coils positioned external to the inter-electrode gap and suitably configured to establish magnetic flux linking both annular parallel formation electrodes within the inter-electrode gap for maintaining equilibrium and stability of the plasma configuration, wherein the solenoid, capacitor or DC electrical power means, gas inlet, breech opening and external magnetic field coils are operative with the annular parallel electrodes to provide for generating and releasing a spheromak.

34. The apparatus of claim 33, further comprising means for producing pulsed formation and release of magnetized plasma.

35. The apparatus of claims 33, further comprising a vacuum vessel.

36. The apparatus of claim 33, wherein the annular parallel electrodes are coated with a material having sufficient refractory properties to protect said electrodes from damage by heat loading.

37. The apparatus of claim 33, wherein the annular parallel electrodes comprise tungsten-coated OFHC copper electrodes.

38. An electrode apparatus for refluxing a quasi-steady state spheromak, comprising:
a plasma chamber magnetically configurable to provide a magnetic well therein sufficient for magnetic containment of a quasi-steady state spheromak;
a pair of spaced annular parallel electrodes defining an annular inter-electrode gap therebetween and radially-inward and radially-outward gap openings, the radially inward gap opening providing an open annular breech for release of toroidal plasma formable within the annular inter-electrode gap, the open annular breech operatively coupled to the magnetic well of the plasma chamber;
a solenoid member and vacuum means suitably configured for generating a vacuum magnetic field in the annular inter-electrode gap, the solenoid member positioned to seal the radially outward gap opening;
a gas inlet and valve means for introducing gas into the annular inter-electrode gap;
capacitor or DC electrical power supply means in electrical communication with the annular parallel electrodes and configured to be pulse dischargable thereto to provide for breakdown of a gas in the annular gap to form a magnetized toroidal plasma (spheromak); and
one or more magnetic field coils positioned external to the inter-electrode gap and suitably configured to establish magnetic flux linking both annular parallel formation electrodes within the inter-electrode gap for maintaining equilibrium and stability of the plasma configuration, wherein the solenoid, capacitor or DC electrical power means, gas inlet, and external magnetic field coils are operative with the annular parallel electrodes, breech opening and magnetic well to provide for pulsed injection of magnetic helicity to form and reflux a quasi-steady state spheromak within the magnetic well of the plasma chamber.

39. The apparatus of claim 38, further comprising a vacuum vessel.

40. The apparatus of claim 38, wherein the annular parallel electrodes are coated with a material having sufficient refractory properties to protect said electrodes from damage by heat loading.

41. The apparatus of claim 38, wherein the annular parallel electrodes comprise tungsten-coated OFHC copper electrodes.

42. The apparatus of claim 38, wherein magnetically configuring the plasma chamber to provide a magnetic well therein sufficient for magnetic containment of a quasi-steady state spheromak comprises a set of externally mounted poloidal field coils and a conducting layer mounted inside a blanket module having sufficient conductivity to establish eddy currents.

43. A method for compression of a magnetized plasma, compact plasma or spheromak, comprising:
providing a magnetized plasma, compact plasma or spheromak in a magnetic well of a plasma compression or combustion chamber; and
compressing the plasma or spheromak using a moveable compression member having at least one compression member magnetic field coil, the compression member and field coil moveable to vary the volume within the compression or combustion chamber to provide for cycled compression and decompression of plasma within the compression chamber.

44. A method for compression of a magnetized plasma, compact plasma or spheromak for fusion-mediated neutron generation, comprising:
providing a magnetized plasma, compact plasma or spheromak in a magnetic well of a plasma compression or combustion chamber; and
compressing the plasma or spheromak to achieve ignition of a fusion regime using a moveable compression member having at least one compression member magnetic field coil, the compression member and field coil moveable to vary the volume within the compression or combustion chamber to provide for cycled compression and decompression of plasma within the compression chamber.

45. A method of compressing a spheromak to provide a fusion reactor, comprising:
providing a spheromak plasma in a magnetic well of a plasma compression or combustion chamber, the chamber operatively coupled to at least one of a direct energy convertor and a blanket layer comprising at least one channel suitably configured to provide for conveyance of a particle absorbing blanket fluid to provide for capturing of plasma-derived particle flux emitted from the combustion chamber;
compressing the spheromak plasma to achieve ignition of a fusion regime using a moveable compression member having at least one compression member magnetic field coil, the compression member and field coil moveable to vary the volume within the compression or combustion chamber to provide for cycled compression and decompression of the plasma within the compression chamber; and
capturing plasma-derived energy or particle flux emitted from the combustion chamber.

46. The method of claim 45, wherein the spheromak comprises a quasi-steady-state spheromak, and wherein the fusion regime provides neutrons that are captured within the blanket medium of the combustion chamber.

47. The method of claim 46, wherein the quasi-steady-state spheromak is derived from a mixture of deuterium and tritium.

48. The method of claim 45, wherein the spheromak plasma is derived from at least one fuel selected from the group consisting of neutronic fuels, aneutronic fuels, deuterium-trirtium (D-T), deuterium-deuterium (D-D), proton-boron-11 (p-B11), and deuterium-helium-3 (D-He3).
